(19) United States
(12) Patent Application Publication
(10) Pub. No.: US 2024/0196272 A1
(43) Pub. Date: Jun. 13, 2024

(54) Methods for Predicting and Signaling Traffic Status and Migration

(71) Applicant: TELEFONAKTIEBOLAGET LM ERICSSON (PUBL), Stockholm (SE)

(72) Inventors: Philipp Bruhn, Aachen (DE); Angelo Centonza, Granada (ES); Luca Lunardi, Genova (IT); Pablo Soldati, Solna (SE); Reem Karaki, Aachen (DE); Henrik Rydén, Stockholm (SE); Ali Parichehrehteroujeni, Linköping (SE)

(21) Appl. No.: 18/554,522

(22) PCT Filed: Apr. 27, 2022
(86) PCT No.: PCT/EP2022/061127

§ 371 Date: Oct. 9, 2023

Related U.S. Application Data
(60) Provisional application No. 63/182,122, filed on Apr. 30, 2021.
(60) Provisional application No. 63/182,287, filed on Apr. 30, 2021.

(51) Int. Cl. H04W 28/086; H04L 47/70; H04W 28/02

(52) U.S. Cl. CPC H04W 28/0861; H04L 47/823; H04W 28/0236; H04W 28/0284

(57) ABSTRACT

Embodiments include methods for a first network node of a wireless network. Such methods include receiving, from a second network node of the wireless network, a first message comprising traffic status information for the second network node and performing one or more of the following operations based on the traffic status information: predicting a change in load and/or interference in a coverage area of the first network node; adjusting configurations of one or more cells and/or one or more beams served by the first network node; requesting the second network node to adjust configurations of one or more cells and/or one or more beams served by the second network node; mobility load balancing with respect to one or more user equipment (UEs) served by the first network node; and configuring one or more UEs served by the first network node to use communication settings that are more robust to interference.

### TECHNICAL FIELD

The present disclose relates generally to wireless communication networks, and more specifically to techniques for improved network resource management based on measurements and/or predictions of data traffic of network nodes serving neighboring coverage areas, and migration of such data traffic into other coverage areas.

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates an exemplary high-level view of the 5G network architecture, consisting of a Next Generation RAN (NG-RAN) 199 and a 5G Core (5GC) 198. NG-RAN 199 can include a set of gNodeB's (gNBs) connected to the 5GC via one or more NG interfaces, such as gNBs 100, 150 connected via interfaces 102, 152, respectively. In addition, the gNBs can be connected to each other via one or more Xn interfaces, such as Xn interface 140 between gNBs 100 and 150. With respect the NR interface to UEs, each of the gNBs can support frequency division duplexing (FDD), time division duplexing (TDD), or a combination thereof.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport. In some exemplary configurations, each gNB is connected to all 5GC nodes within an “AMF Region,” with the term AMF being discussed in more detail below.

The NG RAN logical nodes shown in FIG. 1 include a central (or centralized) unit (CU or gNB-CU) and one or more distributed (or decentralized) units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. Each DU is a logical node that hosts lower-layer protocols and can include, depending on the functional split, various subsets of the gNB functions. As such, each of the CUs and DUs can include various circuitry needed to perform their respective functions, including processing circuitry, transceiver circuitry (e.g., for communication), and power supply circuitry. Moreover, the terms “central unit” and “centralized unit” are used interchangeably herein, as are the terms “distributed unit” and “decentralized unit.”

A gNB-CU connects to gNB-DUs over respective F1 logical interfaces, such as interfaces 122 and 132 shown in FIG. 1. The gNB-CU and connected gNB-DUs are only visible to other gNBs and the 5GC as a gNB. In other words, the F1 interface is not visible beyond gNB-CU.

Self-optimization is a process in which UE and network measurements are used to auto-tune the RAN. This occurs when RAN nodes are in an operational state, which generally refers to the time after the node's RF transmitter interface is switched on. Self-configuration operations include optimization and adaptation, which are generally performed before the RAN nodes are in operational state.

Self-configuration and self-optimization features for NR networks are described in 3GPP TS 38.300 (v16.5.0) section 15 and for earlier-generation Long-Term Evolution (LTE) networks in 3GPP TS 36.300 (v16.5.0) section 22.2. These features include dynamic configuration, automatic neighbor relations (ANR), mobility load balancing (MLB), mobility robustness optimization (MRO), random access channel (RACH) optimization, capacity and coverage optimization (CCO), and mobility settings change.

MLB involves coordination between two or more network nodes to optimize the traffic loads of their respective cells, thereby enabling a better use of radio resources available in a geographic area among served UEs. MLB can involve load-based handover of UEs between cells served by different nodes, thereby achieving “load balancing”.

CCO involves coordination between two or more network nodes to optimize the coverage and capacity offered by their respective cells. For example, a reduced coverage and/or capacity in a cell served by a first network node can be compensated by an increase in the coverage and/or capacity of neighboring cell served by a second network node.

Mobility settings change involves two network node negotiating a mutually-agreeable value for a parameter that triggers UE handover (or other mobility operation) between neighbor cells. This parameter effectively defines a “virtual cell border” experienced by UEs based on their measurements and/or assessments, e.g., of quality and/or strength of reference signals received from the respective cells. For example, a setting change for a handover trigger parameter can expand or shrink the UE's observed coverage area of a serving cell, thereby causing the UE to request a handover to a neighbor cell having a higher measured signal strength and/or quality.

### SUMMARY

Even so, current approaches used for these and other self-configuration/self-optimization features are reactive based on current network conditions and/or current user traffic load. In other words, the current approaches adjust coverage, capacity, load, etc. in response to inputs indicating onset of a degradation in network performance, e.g., due to increased interference, resource utilization, user traffic, etc. However, there can be significant delays between the adjustments and their desired effects, during which the degradation in network performance will continue.

Embodiments of the present disclosure provide specific improvements to communication between user equipment (UE) and network nodes in a wireless network, such as by providing, enabling, and/or facilitating solutions to overcome exemplary problems summarized above and described in more detail below.

Embodiments include methods (e.g., procedures) for a first network node (e.g., base station, eNB, gNB, ng-eNB, etc.) of a wireless network (e.g., E-UTRAN, NG-RAN).

These exemplary methods can include receiving, from a second network node of the wireless network, a first message comprising traffic status information for the second network node. These exemplary methods can also include performing one or more of the following based on the traffic status information:
predicting a change in load and/or interference in a coverage area of the first network node;
adjusting configurations of one or more cells and/or one or more beams served by the first network node;
requesting the second network node to adjust configurations of one or more cells and/or one or more beams served by the second network node;
mobility load balancing (MLB) with respect to one or more UEs served by the first network node; and
configuring one or more UEs served by the first network node to use communication settings that are more robust to interference.

In some embodiments, the traffic status information for the second network node includes the following:
measurements and/or predictions of traffic during one or more time intervals, associated with one or more of the following: respective UEs served by the second network node, an aggregated plurality of UEs served by the second network node, and one or more coverage areas of the second network node; and
indication of predicted traffic migration from the one or more coverage areas of the second network node to one or more coverage areas of the first network node.

In some of these embodiments, the traffic status information for the second network node comprises respective subsets of traffic status information. The respective subsets relate to different ones of any of the following associated with the second network node: cell, beam coverage area, reference signal (RS) coverage area, network slice, tracking area, public land mobile network (PLMN), frequency range, transmission point, resource type.

In some of these embodiments, the traffic status information for the second network node also includes indications of one or more of the following:
accuracy, precision, stability, validity, reliability, precision, and/or uncertainty of the measurements and/or predictions;
the one or more time intervals; and
locations of one or more UEs for which traffic status information is reported.

In some of these embodiments, the traffic status information for the second network node includes one or more of the following traffic metrics: data volume, number of UEs, packet size, bit rate, packet delay, packet delay jitter, packet error rate, number of consecutive failed packets, inter-packet arrival time, service downtime, number of bursts in an application level message, application level message size, end-to-end latency. In some variants, each traffic metric is represented as one of the following, for each time interval:
one or more statistics including average, maximum, minimum, standard deviation, and variance;
a total or aggregate amount; and
predicted change with respect to current traffic, a previous time interval, or a previously reported measurement or prediction.

In some embodiments, the indication of predicted traffic migration (e.g., in the traffic status information for the second network node) includes a plurality of traffic amounts, with each traffic amount being associated with a different combination of a coverage area of the second network node and a coverage areas of the first network node.

In some embodiments, the first message is a handover request for a particular UE served by the second network node and the traffic status information includes one or more of the following: measurements of traffic for the particular UE during one or more previous time intervals, and predictions of traffic for the particular UE during one or more future time intervals.

In some embodiments, these exemplary methods can also include the following: transmitting, to the second network node, a second message including a request for the second network node to provide the traffic status information in accordance with one or more configuration parameters included in the second message; and receiving one of the following from the second network node in response to the second message:
a third message indicating that the second network node can provide some or all of the requested traffic status information and has initiated measurements and/or predictions in accordance with the configuration parameters; or
a fourth message indicating that the second network node cannot provide the requested traffic status information and has not initiated measurements and/or predictions in accordance with the configuration parameters.

In some of these embodiments, the one or more configuration parameters (in the second message) include indications of one or more of the following for which traffic status information is requested:
one or more network slices;
one or more service types;
one or more resource types;
one or more coverage areas of the second network node;
one or more coverage areas of the first network node;
one or more traffic metrics;
one or more time intervals; and
one or more thresholds accuracy, precision, stability, validity, reliability, precision, and/or uncertainty of the measurements and/or predictions.

In some of these embodiments, the one or more configuration parameters (in the second message) include indications of one or more of the following:
one or more reporting formats;
one or more triggering conditions for obtaining the requested traffic status information; and
one or more triggering conditions for reporting the requested traffic status information.

In some embodiments, the traffic status information for the second network node includes a prediction of a change in traffic for one or more UEs in a coverage area of the second network node. In such embodiments, predicting a change in interference in the coverage area of the first network node includes the following: determining that the one or more UEs served by the first network node are proximate to the coverage area of the second network node; and predicting a change in interference to the one or more UEs served by the first network node based on the predicted change in traffic for the one or more UEs in the coverage area of the second network node. Additionally, the one or more UEs served by the first network node are configured to use more robust communication settings based on the predicted change in interference.

In some embodiments, adjusting configurations of one or more cells and/or one or more beams based on the traffic status information can include one or more of the following:
adjusting coverage and/or capacity of at least one of the cells;
adjusting one or more beam coverage areas within the one or more cells;
activating one or more additional cells and/or one or more additional frequency resources in one or more currently activated cells; and
assigning one or more UEs served by the first network node to respective network slices.

In some of these embodiments, predicting a change in load in a coverage area of the first network node comprises predicting that one or more UEs served by the second network node are moving to the coverage area of the first network node. In such case, activating the one or more additional cells and/or the one or more additional frequency resources is responsive to predicting that the one or more UEs served by the second network node are moving to the coverage area of the first network node.

Other embodiments include exemplary methods (e.g., procedures) for a second network node (e.g., base station, eNB, gNB, ng-eNB, etc.) of a wireless network (e.g., E-UTRAN, NG-RAN). In general, these exemplary methods can be complementary to the exemplary methods for a first network node summarized above.

These exemplary methods can include performing one or more of the following operations to determine traffic status information for the second network node:
measuring and/or predicting traffic, during one or more time intervals, that is associated with one or more of the following: respective UEs served by the second network node, an aggregated plurality of UEs served by the second network node, and one or more coverage areas of the second network node; and
predicting traffic migration from one or more coverage areas of the second network node to one or more coverage areas of a first network node of the wireless network.

These exemplary methods can also include sending, to the first network node, a first message comprising the determined traffic status information. In various embodiments, the content of the first message can be the same as in any of the first network node embodiments summarized above.

In some embodiments, these exemplary methods can also include receiving, from the first network node, a second message including a request for the second network node to provide the traffic status information in accordance with one or more configuration parameters included in the second message; and sending one of the following to the first network node in response to the second message:
a third message indicating that the second network node can provide some or all of the requested traffic status information and has initiated measurements and/or predictions in accordance with the configuration parameters; or
a fourth message indicating that the second network node cannot provide the requested traffic status information and has not initiated measurements and/or predictions in accordance with the configuration parameters.
   In various embodiments, the configuration parameters of the second message can be the same as in any of the first network node embodiments summarized above.

In some embodiments, these exemplary methods can also include receiving, from a plurality of UEs served by second network node, measurements and/or predictions of one or more of the following traffic metrics: data volume, packet size, bit rate, packet delay, packet delay jitter, packet error rate, number of consecutive failed packets, inter-packet arrival time, service downtime, number of bursts in an application level message, application level message size, end-to-end latency. In such embodiments, measuring and/or predicting the traffic for the second network node during the one or more time intervals can be based on the measurements and/or predictions received from the plurality of UEs.

In some embodiments, predicting traffic migration from one or more coverage areas of the second network node to one or more coverage areas of the first network node can include determining that one or more UEs served by the second network node are expected to perform mobility operations toward the first network node during a subsequent time interval, based on one or more of the following:
UE position, orientation, and/or speed information determined by the second network node;
UE position, orientation, and/or speed information reported by the respective UEs;
serving cell and/or neighbor cell measurements reported by the respective UEs;
indication of predicted traffic migration from one or more coverage areas of a third network node to one or more coverage areas of the second network node; and
historical UE mobility patterns in the coverage areas in which the one or more UEs are located.

In some embodiments, these exemplary methods can also include receiving, from a third network node of the wireless network, a further first message comprising traffic status information for the third network node. The traffic status information for the second network node is determined based on traffic status information for the third network node.

In some embodiments, these exemplary method can also include, in response to sending the first message comprising the determined traffic status information, receiving from the first network node a request to adjust configurations of one or more cells and/or one or more beams served by the second network node.

Other embodiments include network nodes (e.g., base stations, eNBs, gNBs, ng-eNBs, etc.) configured to perform operations corresponding to any of the exemplary methods described herein. Other embodiments include non-transitory, computer-readable media (e.g., memories) storing program instructions that, when executed by processing circuitry, configure such network nodes to perform operations corresponding to any of the exemplary methods described herein.

Embodiments described herein can facilitate improved management of UEs and network resources by providing a first network node with a richer insight into data traffic of UEs served by a second network node as well as predicted migration of such data traffic into the first network node's coverage area. For example, by using such information, the first network node can improve and/or optimize operations of its served cells, e.g., by interference management and MLB, thereby improving spectral efficiency and throughput in the served cells. As another example, the first network node can infer and/or predict a change in interference to UEs that are served by the first network node (e.g., near cell edge), and proactively configure communication with the affected UEs to be more robust against interference.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 illustrate two high-level views of an exemplary 5G/NR network architecture.

FIG. 3 shows an exemplary configuration of NR user plane (UP) and control plane (CP) protocol stacks.

FIGS. 4A-4B show signal flows for procedures related to resource status reporting between nodes in an NG-RAN.

FIGS. 5A-5B show signal flows for procedures related to mobility settings change between nodes in an NG-RAN.

FIGS. 6 and 7A-B show signal flows between a first network node and a second network node, according to various embodiments of the present disclosure.

FIGS. 8-9 show signal flows between a network node and a UE, according to other embodiments of the present disclosure.

FIG. 10 shows a flow diagram of an exemplary method for a first network node (e.g., base station, eNB, gNB, ng-eNB, etc.), according to various embodiments of the present disclosure.

FIG. 11 shows a flow diagram of an exemplary method for a second network node (e.g., base station, eNB, gNB, ng-eNB, etc.), according to various embodiments of the present disclosure.

FIG. 12 shows a flow diagram of an exemplary method for a network node (e.g., base station, eNB, gNB, ng-eNB, etc.), according to various embodiments of the present disclosure.

FIG. 13 shows a flow diagram of an exemplary method for a UE (e.g., wireless device), according to various embodiments of the present disclosure.

FIG. 14 shows a communication system according to various embodiments of the present disclosure.

FIG. 15 shows a UE according to various embodiments of the present disclosure.

FIG. 16 shows a network node according to various embodiments of the present disclosure.

FIG. 17 shows host computing system according to various embodiments of the present disclosure.

FIG. 18 is a block diagram of a virtualization environment in functions implemented by some embodiments of the present disclosure may be virtualized.

FIG. 19 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the enclosed embodiments will be apparent from the following description.

Furthermore, the following terms are used throughout the description given below:
Radio Node: As used herein, a “radio node” can be either a “radio access node” or a “wireless device.”
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some examples of a wireless device include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc.
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Base station: As used herein, a “base station” may comprise a physical or a logical node transmitting or controlling the transmission of radio signals, e.g., eNB, gNB, ng-eNB, en-gNB, centralized unit (CU)/distributed unit (DU), transmitting radio access node, transmission point (TP), transmission reception point (TRP), remote radio head (RRH), remote radio unit (RRU), Distributed Antenna System (DAS), relay, etc.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

As briefly mentioned above, current approaches used for LTE and NR self-configuration/self-optimization features are reactive based on current network conditions and/or current UE traffic load. In other words, the current approaches adjust coverage, capacity, load, etc. in response to inputs indicating onset of a degradation in network performance, e.g., due to increased interference, resource utilization, user traffic, etc. However, there can be significant delays between the adjustments and their desired effects, during which the degradation in network performance will continue. This is discussed in more detail below after the following description of NR network architecture and protocols.

FIG. 2 shows a high-level view of an exemplary 5G network architecture, including NG-RAN 299 and 5GC 298. As shown in the figure, NG-RAN 299 can include gNBs (e.g., 210a,b) and ng-eNBs (e.g., 220a,b) that are interconnected via respective Xn interfaces. The gNBs and ng-eNBs are also connected via NG interfaces to 5GC 298, more specifically to the Access and Mobility Management Functions (AMFs e.g., 230a,b) via respective NG-C interfaces and to User Plane Functions (UPFs, e.g., 240a,b) via respective NG-U interfaces. Moreover, the AMFs can communicate with one or more policy control functions (PCFs, e.g., 250a,b) and network exposure functions (NEFs, e.g., 260a,b).

Each of the gNBs 210 can support the NR radio interface including frequency division duplexing (FDD), time division duplexing (TDD), or a combination thereof. Each of ng-eNBs 220 can support the LTE radio interface. Unlike conventional LTE eNBs, however, ng-eNBs 220 connect to the 5GC via the NG interface. Each of the gNBs and ng-eNBs can serve a geographic coverage area including one more cells, such as exemplary cells 211a-b and 221a-b shown in FIG. 2. Depending on the cell in which it is located, a UE 205 can communicate with the gNB or ng-eNB serving that cell via the NR or LTE radio interface, respectively. Although FIG. 2 shows gNBs and ng-eNBs separately, it is also possible that a single NG-RAN node provides both types of functionality.

5G/NR technology shares many similarities with LTE. For example, NR uses CP-OFDM (Cyclic Prefix Orthogonal Frequency Division Multiplexing) in the DL and both CP-OFDM and DFT-spread OFDM (DFT-S-OFDM) in the UL. As another example, in the time domain, NR DL and UL physical resources are organized into equal-sized 1-ms subframes. A subframe is further divided into multiple slots of equal duration, with each slot including multiple OFDM-based symbols. However, time-frequency resources can be configured much more flexibly for an NR cell than for an LTE cell. For example, rather than a fixed 15-kHz OFDM sub-carrier spacing (SCS) as in LTE, NR SCS can range from 15 to 240 kHz, with even greater SCS considered for future NR releases.

In addition to providing coverage via cells as in LTE, NR networks also provide coverage via “beams.” In general, a downlink (DL, i.e., network to UE) “beam” is a coverage area of a network-transmitted reference signal (RS) that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DM-RS, PTRS) are associated with specific UEs that have a network connection.

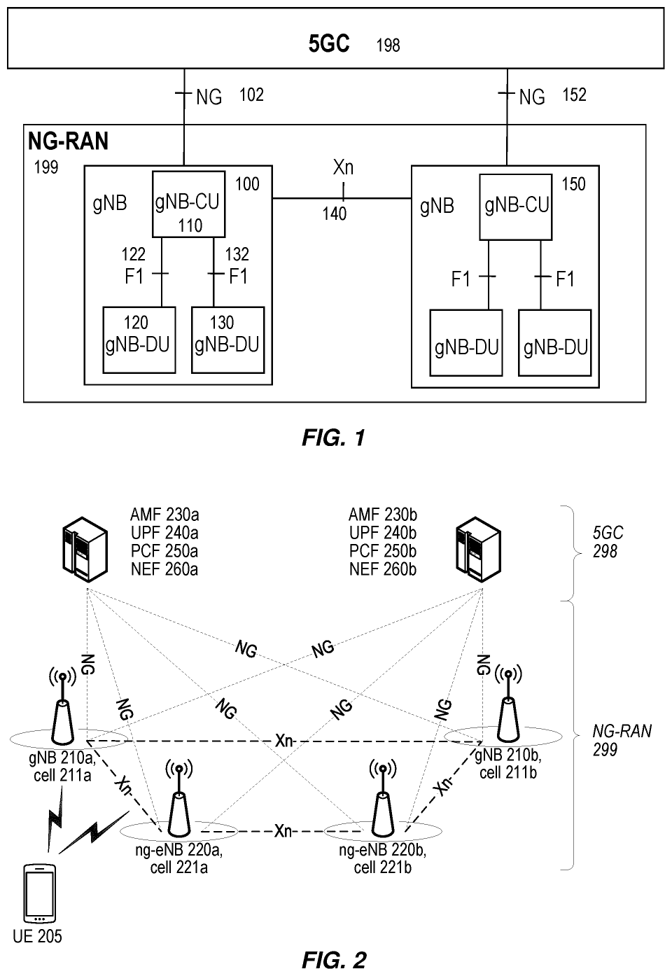

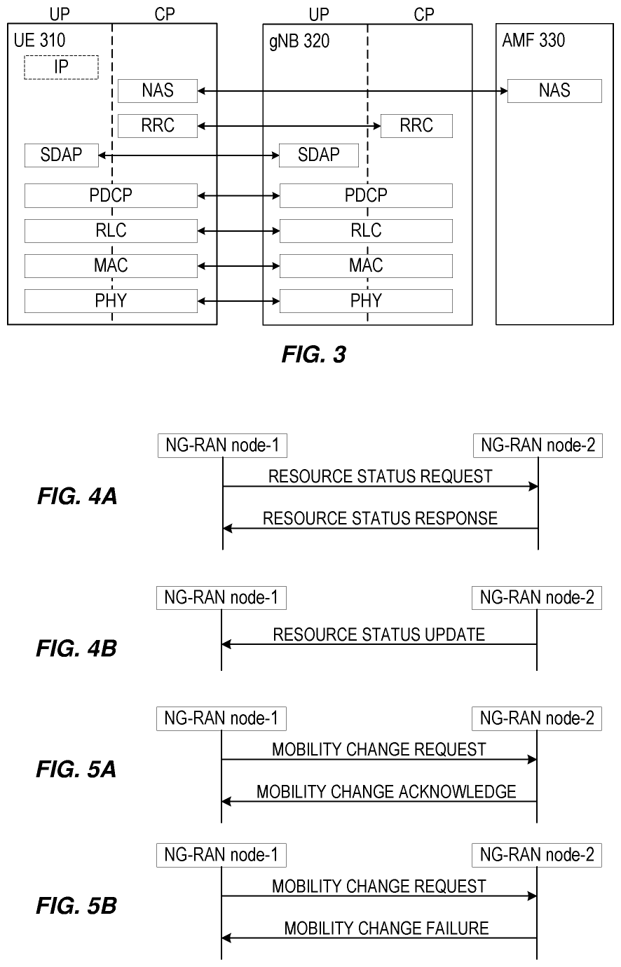

FIG. 3 shows an exemplary configuration of NR user plane (UP) and control plane (CP) protocol stacks between a UE (310), a gNB (320), and an AMF (330), such as those shown in FIGS. 1-2. The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. The RLC layer transfers PDCP PDUs to the MAC through logical channels (LCH). RLC provides error detection/correction, concatenation, segmentation/reassembly, sequence numbering, reordering of data transferred to/from the upper layers. The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

The gNB-CUs shown in FIG. 1 can be further divided into two logical entities: gNB-CU-UP, which serves the UP and hosts PDCP; and gNB-CU-CP, which serves the CP and hosts PDCP and RRC layers. In addition, gNB-DUs hosts RLC, MAC, and PHY layers.

A RAN node can exploit several types of information for operations such as mobility load balancing (MLB), mobility robustness optimization (MRO), capacity and coverage optimization (CCO), and mobility settings change. One information source is resource status information exchanged between RAN nodes using a “Resource Status Reporting” procedure. This procedure is performed over the X2AP (for E-UTRAN) or XnAP (for NG-RAN) interfaces, whereby one RAN node sends a Resource Status Update message to another RAN node. Other relevant procedures include Resource Status Reporting Initiation (for both E-UTRAN and NG-RAN), EN-DC Resource Status Reporting Initiation (for E-UTRAN only), and EN-DC Resource Status Reporting (for E-UTRAN only). These are further defined in the X2AP and XnAP specifications, respectively 3GPP TS 36.423 (v16.5.0) and 3GPP TS 38.423 (v16.5.0).

FIG. 4A shows an exemplary Resource Status Reporting Initiation procedure between two NG-RAN nodes (e.g., gNBs or ng-eNBs) over XnAP. In this procedure, a first NG-RAN node can request a one-time or periodic reporting of load measurements by a second NG-RAN node. The first NG-RAN node initiates the procedure by sending the RESOURCE STATUS REQUEST message to the second NG-RAN node to start, stop or add cells to report for a measurement. The RESOURCE STATUS REQUEST message indicates the type of load metrics the second NG-RAN node shall measure. Depending on the preceding request, the RESOURCE STATUS UPDATE message by the second NG-RAN node can include one of more of the following:
Load information on a per SSB coverage area granularity, such as radio resource utilization (e.g. PRB utilization) per SSB coverage area, composite available capacity per SSB coverage area, etc.
Load information on a per network slice granularity, such as slice available capacity per network slice.
Load information on a per cell granularity, such as TNL capacity indication, number of active UEs, number of RRC connections, etc.

After a successful Resource Status Reporting Initiation procedure, the second NG-RAN node reports the results of the agreed-upon information once or periodically via the Resource Status Reporting procedure. FIG. 4B shows an exemplary Resource Status Reporting procedure between two NG-RAN nodes (e.g., gNBs or ng-eNBs) over XnAP. The second NG-RAN node uses the RESOURCE STATUS UPDATE message for the reporting.

CCO is an important building block of self-organizing networks (SON) for both LTE and NR. In general, CCO attempts to provide a required network capacity in a particular coverage area while minimizing interference and maintaining an acceptable quality of service (QoS) to users. Standardization of NR CCO is ongoing, with the LTE CCO solution used as a baseline. 3GPP TR 37.816 (v16.0.0) discusses various use cases for NR CCO but classifies them into two more generic scenarios of coverage problems and capacity problems.

The first involves scenarios in which reference signal (RS) coverage is sub-optimal, leaving UEs exposed to failures or degraded performance. Examples include coverage holes and UL/DL disparities. While MRO is intended to address all types of failures due to incorrect mobility settings within a network with good coverage, CCO is intended address scenarios having a root cause of poor coverage planning.

The second involves scenarios in which capacity within a cell or beam is saturated, resulting in one or more UEs being subject to failures or suboptimal performance. There are a number of reasons for such problems, including demand exceeding resources available in the cell/beam and poor radio conditions affecting a large portion of UEs served by the cell/beam. For example, when a large number of UEs are at or near a cell edge, they will consume a larger amount of resources per-UE and their increased transmission power will interfere with other UEs.

MLB is intended to address load distribution via mobility and is done mainly in inter-frequency scenarios, where cross-cell interference is not an issue. In contrast, CCO is intended to address scenarios having a root cause of UE concentration at an “edge” between cells or beams that use the same resources.

In general, CCO solutions adapt cell/beam coverage to achieve better system performance. They generally include two components: detection of a coverage and/or capacity issue, and action to resolve the issue. Information used by a CCO solution to detect coverage and capacity issues can include:
Per source cell/beam RS measurements from UEs
Per target(s) beam/cell RS measurement from UEs
Information on failure events associated with source and target cells, such as UE measurements on source and target reference signals (e.g., SSBs) at the time of failure, which can be included in UE radio link failure (RLF) reports;
Information about RACH access;
Interference measurements on a per UE basis; and
Cell load and other performance information from the target cell and the neighbor cells: this information enables the CCO function to determine relative capacity situation between the target and the neighbor cells and identify potential candidate cells for coverage and capacity coordination.

As briefly mentioned above, mobility settings change involves two network node negotiating a mutually-agreeable value for a parameter that triggers UE handover (or other mobility operation) between neighbor cells. This parameter effectively defines a “virtual cell border” experienced by UEs based on their measurements and/or assessments, e.g., of quality and/or strength of reference signals received from the respective cells. Mobility setting change procedures use UE-associated signaling.

FIG. 5A shows an exemplary signal flow for a successful Mobility Setting Change procedure between two NG-RAN nodes (e.g., gNBs or ng-eNBs) over XnAP. In this procedure, a first NG-RAN node initiates the procedure by sending a MOBILITY CHANGE REQUEST message to a second NG-RAN node, with the message including a proposed modification to a handover trigger parameter. Upon receipt, the second NG-RAN node evaluates whether the proposed handover trigger modification is acceptable. In the case shown in FIG. 5A, the second NG-RAN node determines that the proposed handover trigger modification is acceptable and replies with MOBILITY CHANGE ACKNOWLEDGE message.

FIG. 5B shows an exemplary signal flow for an unsuccessful Mobility Setting Change procedure between two NG-RAN nodes (e.g., gNBs or ng-eNBs) over XnAP. In this scenario, the proposed parameter modification is not acceptable to the second NG-RAN node or the second NG-RAN node is not able to complete the procedure. As such, the second NG-RAN node sends a MOBILITY CHANGE FAILURE message with a Cause information element (IE) set to an appropriate value. Optionally, the second NG-RAN node can include a Mobility Parameters Modification Range IE in the MOBILITY CHANGE FAILURE message, such as when the proposed modification is out of a permitted range.

MLB decisions can be made by a first network node (e.g., NG-RAN node) based on load metrics reflecting measurements taken by a second network node (e.g., NG-RAN node) and reported to the first network node. For example, the first network node may consider such metrics to assess which cell is the most suitable handover target for one or more UEs. In another example, network energy saving decisions, like the deactivation of capacity cells, are commonly taken based on cell load information. Similarly, a network node can estimate or forecast mobility events for one or more UEs that is serves. For example, based on neighbor cell measurements, the network node can deduce or predict that the one or more UEs are moving in the direction of a target cell.

Currently, however, the network node serving the UEs (referred to as “serving network node”) is not able to signal to a network node serving a potential target cell (referred to as “target network node”) a prediction of the traffic that the UE may generate. Note that such a prediction is different than the amount of resources predicted by the serving network node to serve future traffic demands of the UE. Rather, it is a prediction provided by the UE about data traffic requirements of services and/or applications ongoing (or expected to be initiated) at the UE. Similarly, current solutions do not support exchange of predicted traffic migration between cells served by different network nodes.

With respect to NR, the current Resource Status Reporting procedures specified for XnAP, X2AP, F1 and E1 interfaces do not provide a first network node any insight about impact of traffic measured/predicted/reported by the second network node can have on the resources controlled by the first network node, particularly in relation to the second network node's predicted mobility of such traffic toward the first network node.

Furthermore, under current approaches, a RAN node is unable to obtain measurements and/or predictions from a UE that reflect future data traffic requirements of the applications that the UE is or will be using. Since the UE's future data traffic requirements will affect network performance, the RAN node is unable to fully optimize and/or improve management of available resources to meet future traffic requirements. As such, the RAN node is forced into a reactive approach to managing available resources, e.g., in response to detected degradations in network performance.

Although it is possible to use network-based prediction of future UE data traffic requirements, these network-based methods necessarily lack certain important information available only at the UE. For example, a RAN node is generally unaware of UE environmental factors and/or usage patterns of applications run by the UE, both of which could facilitate improved user traffic predictions and more proactive management of available resources to meet future traffic requirements.

Accordingly, some embodiments of the present disclosure provide flexible and efficient techniques for signaling measured and/or predicted traffic status and predicted traffic migration between network nodes in the RAN, which can be used as input to many network algorithms for UE and network resource management, such as MLB, CCO, energy consumption reduction, QoS assessment, etc.

At a high level, these embodiments can include methods for reporting traffic status by a second network node to a first network node, wherein the traffic status can include any of the following:
measurements and/or predictions of aggregated (e.g., for multiple UEs, for a coverage area, etc.) or UE-associated traffic information at the second network node,
measurements and/or predictions of traffic migration, in aggregated (e.g., for multiple UEs, for a coverage area, etc.) or UE-associated form, from the second network node towards the first network node, and

In various embodiments, measurements and/or predictions of the traffic status at the second network node can be reported to the first network node in various granularities, such as:
per network slice, per cell, per SSB or CSI-RS coverage area, etc.;
per type of traffic, such as data, voice, video, V2X, URLLC, etc.; and
per type of resource, such as non-GBR, GBR, or delay critical GBR.

In various embodiments, the measurements and/or predictions of the traffic information that second network node reports to the first network node can include any of the following, individually or in combination:
an indication of traffic migration from coverage areas (e.g., cells, SSB beam coverage areas, CSI-RS beam coverage areas, etc.) of the second network node toward coverage areas (e.g., cells, SSB beam coverage areas, CSI-RS beam coverage areas, etc.) of the first network node;
an indication of traffic per network slice measured or predicted to migrate;
an indication of types of traffic and/or resource measured or predicted to migrate; and
as part of mobility signaling (e.g., handover preparation messages) to a target network node, an indication of the traffic status of the UE measured and/or predicted at the source network node.

Upon collecting predictions of the UE's data traffic requirements, the network node may use such information to optimize future network operation towards the UE, such as allocation of resources, configuration of measurements, preparation for handover, etc. Additionally, upon collecting predictions of the data traffic requirements from multiple UEs and combining such information with mobility-related information reported by the UEs, the network node can more reliably predict and/or estimate both traffic load and traffic mobility patterns in a relevant coverage area, e.g., one or more cells, one or more SSB beams, etc. Furthermore, the network can use such predictions and/or estimates to optimize and/or improve operations, such as by configuration of cells and/or beams to provide optimal coverage and capacity (e.g., via CCO), perform MLB and/or mobility setting changes, etc.

These embodiments can provide various advantages, benefits, and/or solutions to problems. For example, a network node receiving traffic status reports from another (neighboring) network node gains knowledge of the actual data traffic at the neighboring network node, e.g., per cell, pr SSB coverage area, per CSI-RS coverage area, etc. The network node can use this information to improve and/or optimize operations of its served cells, e.g., by interference management and MLB, thereby improving spectral efficiency and throughput in the served cells.

As another example, by receiving indications of predicted traffic migration from coverage areas (e.g., cells and/or beams) of a second (neighboring) network node toward the coverage areas (e.g., cells and/or beams) of the first network node, the first network node can proactively optimize mobility events and/or MLB, which can prevent occurrences of excessive load, interference, and/or congestion in its served cells. This can result in improvements to spectral efficiency, throughput, and latency in the first network node's served cells.

As another example, embodiments facilitate a first network node to obtain insight from a second network node that a group of UEs, at the edge of cell(s) that neighbor the cells by the first network node, are predicted to generate and/or consume more traffic. Based on this information, the first network node can infer and/or predict a change (e.g., increase or decrease) in interference to proximate UEs that are served by the first network node (e.g., near cell edge), and proactively configure communication with the affected UEs to be more robust against interference, e.g., by change in modulation and coding scheme (MCS).

In the following description, the terms “traffic”, “traffic status”, “traffic information”, “traffic status information”, and “traffic status update” are used interchangeably with the same meaning, unless explicitly stated to the contrary.

In the following description, the terms “UE traffic state”, “UE traffic state information”, “user-related traffic information”, “traffic state report”, and “UE traffic state report” are used interchangeably with the same meaning, unless explicitly stated to the contrary.

In the following description, the term “message” is used generically to refer to any type of structured information carrier used by a first entity to send information to a second entity. Specific examples include messages or information elements (IEs) defined (or to be defined) in 3GPP specifications for existing or newly-defined interfaces, architectures, and/or protocol layers (e.g., RRC, MAC, Xn, F1AP, etc.).

Additionally, “message” is often used herein together with a numerical modifier, e.g., “first message, “second message”, etc. These numerical adjectives do not imply a strict temporal ordering of such messages, unless explicitly stated to the contrary. Rather, they are used to distinguish between different messages having different content.

Furthermore, a first entity receiving a message “from” a second entity does not foreclose the possibility that the message travels on a path through one or more intermediate entities. Likewise, a first entity transmitting a message “to” a second entity does not foreclose the possibility that the message travels on a path through one or more intermediate entities.

Examples of algorithms that a network node could use to predict and/or estimate traffic status information may include traditional estimation methods (e.g., maximum like likelihood algorithms, Kalman filters, etc.) or artificial intelligence/machine learning (AI/ML)-based techniques (e.g., supervised learning methods, deep learning algorithms, autoregression algorithms, etc.). Certain AI/ML algorithms may exploit functional approximation models, such as neural networks (e.g., feedforward neural networks, deep neural networks, recurrent neural networks, convolutional neural networks, etc.), which can be trained to estimate a traffic metric of interest based on prior data samples collected by the network node itself, and/or other network nodes, and/or by UEs served by the network node itself.

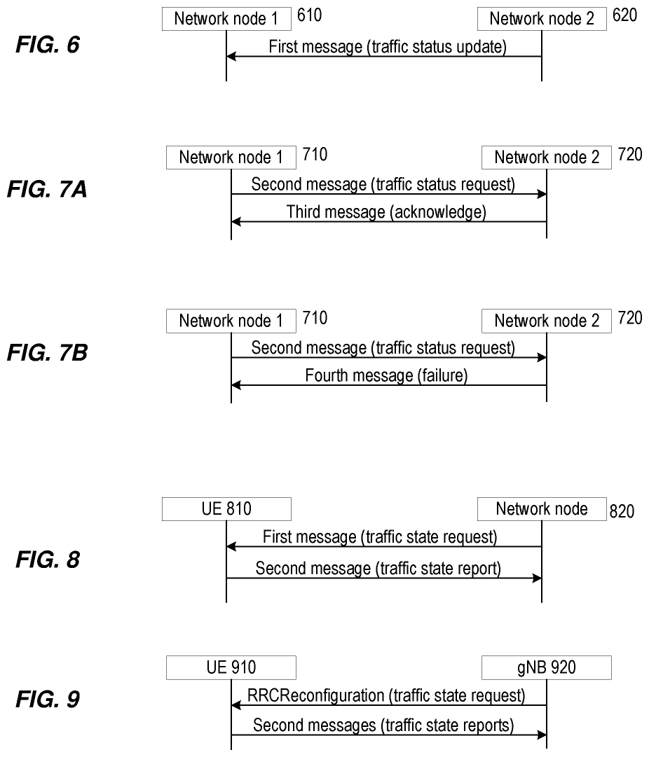

In some embodiments, a second network node can use a procedure, either an existing procedure or a newly defined procedure (e.g., called Traffic Status Reporting or a similar name), to send a first message (e.g., called TRAFFIC STATUS UPDATE or a similar name), to perform a one-time or periodic reporting of traffic measurements and/or predictions (e.g., called traffic status information or a similar name) to the first network node. FIG. 6 shows a flow diagram that illustrates some of these embodiments, particularly for signaling between a first network node (610) and a second network node (620). Skilled persons will recognize that the signaling shown in FIG. 6 can be easily extended to the second network node sending multiple (e.g., periodic) first messages to the first network node, each containing traffic status information. Likewise, skilled persons will recognize that the signaling shown in FIG. 6 can be easily extended to multiple second network nodes, each sending a first message to the first network node containing traffic status information.

In various embodiments, the second network node can report the traffic measurements and/or predictions, separately or cumulatively for DL and UL, according to any of the following granularities:
per cell,
per SSB coverage area,
per CSI-RS coverage area,
per network slice,
per Tracking Area,
per PLMN,
per Frequency Range (e.g., FR1, FR2),
per carrier frequency,
per transmission point,
per traffic type (e.g., data, voice, video, V2X, URLLC, etc.),
per resource type (e.g., non-GBR, GBR, or delay critical GBR),

In some embodiments, the first message sent by the second network node to the first network node can include one or more of the following information (e.g., according to any of the granularities listed above):
a measured traffic status (also referred to as “traffic measurement”),
a predicted traffic status (also referred to as “traffic prediction”), and
an indication of a predicted traffic migration from one or more coverage areas of the second network node to one or more coverage areas of the first network node.

In some embodiments, the traffic measurements and/or predictions sent by the second network node to the first network node in the first message can take any of the following forms:
total, average, minimum, maximum, variance, standard deviation, etc. of traffic measured and/or predicted with respect to one or more time intervals;
indication(s) of validity, accuracy, reliability, stability, and/or precision of the measurements and/or predictions; and
indication of relevant time interval(s) for the measurements and/or predictions reported traffic measurements and/or predictions.

In some embodiments, at least some of the traffic status information reported by the second network node can be obtained from one or more UEs served by the second network node. Such traffic status information obtained from the UE(s) can include any of the following:
predicted bit rate requested from a given time or within a given time window,
predicted data volume requested from a given time or within a given time window,
predicted packet delay requested from a given time or within a given time window,
predicted packet delay jitter requested from a given time or within a given time window,
predicted packet error rate requested from a given time or within a given time window,
predicted number of consecutively failed package deliveries requested from a given time or within a given time window,
predicted number of bursts in an application level message,
predicted application level message size,
predicted end-to-end latency,
predicted service downtime, namely a measure of maximum time during which the service can remain unserved (e.g., no packets can be transmitted for the service) without impacts on the target service quality, and
indication(s) of validity, accuracy, reliability, stability, and/or precision of the UE predictions.
   Once the metrics above are received from the UE, the second network node can report them in an aggregated format (i.e., for multiple UEs) and/or on a per-UE basis and in different ways to neighboring network nodes. The list below provides examples of such reporting, where one of more reporting criteria can be used in combination:
The second network node can report aggregated traffic status information for several UEs on a per network slice basis. Namely, it can aggregate all the predictions from UEs and services associated to a certain network slice and report them to a neighboring network node for that specific network slice.
The second network node can report aggregated traffic status information for a number of UEs per cell, per SSB coverage area, per CSI-RS coverage area, etc. The reported information may be aggregated based on one or more of the following:
   cell, SSB coverage area, and/or CSI-RS coverage area of the second network node that serves the aggregated UEs, and/or
   cell, SSB coverage area, and/or CSI-RS coverage area of the first network node, to which the aggregated UEs are expected and/or predicted to move.
The second network node can report UE-associated traffic status information as part of UE-associated signaling to a neighbor network node, e.g., as part of the Handover Preparation procedure. In this case, the first network node will be informed that the UE is prepared to be handed over to it as a target network node and of the predicted traffic status for the UE.

In various embodiments, the second network node may predict the traffic status in the future based on the results of traffic status measurements in the past, e.g., based on an autoregressive or moving average model. In some embodiments, the second network node can also use traffic migration indications received from one or more neighboring network nodes by a first message. In that case, it can use the included traffic status estimate to improve its traffic status prediction. In some embodiments, the second network node can also use RRC reconfiguration procedures to request/configure one or more UEs to report predictions of their traffic status, e.g., in the form of UE assistance information or similar.

In various embodiments, the second network node can predict mobility behavior (e.g., a next cell) for moving UEs based on various types of information including any of the following:
Standard positioning methods supported by NG-RAN (e.g., as defined in 3GPP TS 38.305, e.g., v16.4.0),
UE measurements (i.e., RSRP measurements for serving and neighboring cells),
UE sensor information (e.g., orientation), and
UE mobility patterns, e.g., historical UE trajectories and/or mobility actions.

In general, the indication of the traffic migration included in the traffic status information is a prediction of to where the measured and/or predicted traffic will migrate over time due to mobility of UEs, which will result in a change in load distribution in the network. Such forecasts are made based on traffic and mobility information the second network node measures and/or predicts for the UEs causing network load. For example, the second network node may deduce from neighbor cell measurements that certain UEs are moving toward specific target cells. Based on this, the second network node can predict that, within a given time window, a certain amount of traffic currently served by the second network node (and reported in the traffic status information) will move to the first network node. In some embodiments, the second network node can indicate one or more cells, SSB coverage areas, CSI-RS coverage areas, network slices, Tracking Areas, PLMNs, Frequency Ranges, carrier frequencies, and/or transmission points (TPs) of the first network node to which the predicted traffic is expected to be transferred.

In some embodiments, the traffic status information reported by the second network node can be included in a message of a Handover Preparation procedure. In this procedure, the second network node initiates a handover procedure and indicates (e.g., as part of the HANDOVER REQUEST message) the traffic status information (e.g., current and predicted) of the UE(s) to be handed over to the first network node. For example, the first message shown in FIG. 6 can be a HANDOVER REQUEST message.

In some embodiments, the traffic status information reported by the second network node can include an uncertainty level between the predicted future traffic and actual future traffic. This applies to the traffic status metrics measured and/or predicted at a point in time before the signaling of a first message as well as a HANDOVER REQUEST message to the first network node.

In some embodiments, a first network node may request from a second network node traffic status reports for UEs that are not predicted to move towards the first network node. This may be useful for the first network node to predict situations of cross cell interference. For example, it is useful for the first network node to know that a group of UEs at the edge of cells neighboring the severed cells is predicted to generate and/or consume more traffic, since these UEs may interfere with UEs in the cells served by the first network node. Based on receiving such traffic status information from the second network node, the first network node can proactively perform preventive actions, such as configuring communication with cell-edge UEs (i.e., proximate to the interfering UEs) via a more robust channel configuration.

In some embodiments, the Traffic Status Reporting procedure discussed above can be initiated by another procedure (e.g., called Traffic Status Reporting Initiation or a similar name), which can be either an existing procedure or a newly defined procedure. As part of the Traffic Status Reporting Initiation procedure, the second network node can receive a second message (e.g., called TRAFFIC STATUS REQUEST or a similar name), from the first network, indicating a request for one-time or a periodic reporting of the traffic measurements and/or predictions discussed above. The second message can include requests for one of more of the following:
a measured traffic status at the second network node, and/or
a predicted traffic status at the second network node, and/or
indication of traffic migration from coverage areas (e.g., cells, SSB beam coverage areas, CSI-RS beam coverage areas) of the second network node toward coverage areas (e.g., cells, SSB beam coverage areas, CSI-RS beam coverage areas) of the first network node;
an indication of one or more types of traffic (e.g., data, voice, video, V2X, URLLC, etc.) for which to report measured and/or predicted traffic status;
an indication of one or more types of resources (e.g., non-GBR, GBR, or delay critical GBR, etc.) for which to report measured and/or predicted traffic status;
an indication of one or more network-related granularities (e.g., per cell, per SSB coverage area, per network slice, etc.) for which to report measured and/or predicted traffic status;
indications of reporting constraints (e.g., validity within a certain time window, above a certain level of accuracy or precision, etc.).

Depending on its capabilities, the second network node can respond to the second message either with a third message, indicating that it can provide some or all of the requested traffic status information and has initiated the traffic measurement as requested by the first network node, representing a successful Traffic Status Reporting Initiation procedure; or a fourth message, indicating that it cannot provide the requested traffic status information and has not initiated the traffic measurement as requested by the first network node, therefore representing an unsuccessful.

FIGS. 7A-B show flow diagrams that illustrate exemplary successful and unsuccessful Traffic Status Reporting Initiation procedures, respectively. In case of a successful Traffic Status Reporting Initiation procedure (e.g., FIG. 7A), the second network node (720) sends the results of traffic measurements and/or predictions by the first message (e.g., in FIG. 6), as requested by the first network node (710) in the second message and admitted by the second network node in the third message.

In some embodiments, the second network node, receiving the second message, starts or stops a traffic measurement, or adds cells to ongoing traffic measurements and/or predictions. Depending on the information requested by the first network node, the second network node measures and/or predicts and subsequently reports the traffic status on a per cell, per beam coverage area, and/or per network slice basis, separately or cumulatively for DL and UL.

In some embodiments, the second message sent by the first network node can indicate to the second network node that an ongoing traffic status reporting shall be stopped. In such embodiments, the first network node can receive from the second network node a first message with an indication that traffic status reporting was stopped at the second network node.

In some embodiments, the second message sent by the first network node can contain a forecast period for which the second network node shall report the predicted traffic status. If such forecast period is not included, it can indicate that the forecast period coincides with a reporting periodicity.

In some embodiments, the first network node, receiving a measured and/or predicted traffic status from the second network node, may use this information to improve and/or optimize operations of its served cells, e.g., by interference management and MLB, thereby improving spectral efficiency and throughput in the served cells. Additionally, the first network node can proactively optimize mobility events and/or MLB, which can prevent occurrences of excessive load and/or interference in its served cells. Some more specific examples are given below:
The first network node can rearrange its resource allocation to existing bearers to make room for the forecasted traffic.
The first network node can predict interference level at the UE(s) (i.e., in the DL) and at the cell site(s) (i.e., in the UL) and use such information to improve resource management-related decisions, e.g., to briefly postpone the scheduling of traffic with a relaxed packet delay budget at times when the predicted interference level exceeds a certain threshold.
The first network node can decide to offload one or more UEs to cells neighbor served by the second network node, by performing intra-frequency, inter-frequency, or inter-RAT handover. This can be done to resolve an identified excessive load (e.g., congestion) or excessive interference or avoid a foreseen excessive load or excessive interference in the future in a cell served by itself. This can be done to facilitate reduced energy consumption and/or increased energy efficiency, e.g., by turning off cell(s) predicted to have relatively low traffic.
The first network node can decide to activate new cells and/or new frequency resources to make room for a forecasted increase in traffic.

In some embodiments, the first network node can perform resource management operations similar to those described above based on receiving an indication of traffic migration from the second network node. Some more specific examples are given below:
The first network node can decide to offload certain UEs to neighboring cells, different frequency bands, different SSB beam coverage areas, etc. to free up resources to accommodate the predicted incoming traffic demand and avoid predicted future excessive load (e.g., congestion) and/or interference.
The first network node can decide to configure certain UEs to report certain cell- and/or beam-level measurements on SSB and/or CSI-RS to facilitate MLB or other resource management operations.
The first network node can decide to request one or more network nodes serving neighboring coverage areas to report of load and/or traffic measurements to facilitate MLB or other resource management operations.
The first network node can decide to activate one or more cells for increased capacity, and/or to request another network node to activate one or more cells for increased capacity in a neighboring coverage area, in order to accommodate the predicted incoming traffic demand. These cells may have been previously deactivated to reduce energy consumption.
The first network node can decide to adjust (e.g., increase or decrease) its capacity by adjusting its antenna configuration, active sleep mode, or its operating bandwidth.

There can be various reasons or triggers for a first network node to request traffic status measurements, predictions, and/or indications of traffic migration by a second network nodes. For example, the first network node can detect and/or observe a relatively high interference level in one or more of its coverage areas (e.g., cell, beam, etc.), whether DL interference at served UEs and/or UL interference at the cell site (i.e., in UL), in its responsibility in the DL and/or the UL. As another example, the first network node can detect, observe, and/or predict relatively high load and/or interference levels (e.g., based on one or more load-related metrics being above a threshold) in one or more of its coverage areas (e.g., cell, beam, etc.). As another example, the first network node can detect, observe, and/or predict a problem with energy efficiency and/or demand (e.g., based on energy demand being above a threshold) in one or more of its coverage areas (e.g., cell, beam, etc.).

Certain embodiments can be realized as messages in protocols specified by 3GPP for communication between network nodes. One example implementation of the second message discussed above is given below for XnAP defined in 3GPP TS 38.423.
**Begin exemplary text for 3GPP TS 38.423**
9.1.3.X1 TRAFFIC STATUS REQUEST
This message is sent by NG-RAN node₁ to NG-RAN node₂ to initiate the requested measurement according to the parameters given in the message.
Direction: NG-RAN node 1 to NG-RAN node 2.

| IE/Group Name | Presence | Range | IE type/ref. | Semantics description |
|---|---|---|---|---|
| Message Type | M | | 9.2.3.1 | |
| NG-RAN node₁ | M | | INTEGER | Allocated by NG-RAN node 1 |
| Measurement ID | | | (1 . . . 4095, . . . ) | |
| NG-RAN node₂ | C- | | INTEGER | Allocated by NG-RAN node 2 |
| Measurement ID | ifRegistration | | (1 . . . 4095, . . . ) | |
| | Request | | | |
| | StoporAdd | | | |
| Registration Request | M | | ENUMERATED | Type of request for which the |
| | | | (start, stop, | traffic status is required. |
| | | | add, . . . ) | |
| Report Characteristics | C- | | BITSTRING | Each position in the bitmap |
| | ifRegistration- | | (SIZE(32)) | indicates measurement object |
| | RequestStart | | | the NG-RAN node₂ is requested |
| | | | | to report. |
| | | | | First Bit = Current Traffic Status |
| | | | | Periodic, Second Bit = Future |
| | | | | Traffic Status Periodic, Third |
| | | | | Bit = Traffic Migration Indication. |
| | | | | Other bits shall be ignored by the |
| | | | | NG-RAN node 2. |
| Cell To Report List | | 0 . . . 1 | | Cell ID list to which the request |
| | | | | applies. |
| >Cell To Report Item | | 1 . . . | | |
| | | <maxnoof | | |
| | | CellsinNG- | | |
| | | RANnode> | | |
| >>Cell ID | M | | Global NG-RAN | |
| | | | Cell Identity | |
| | | | 9.2.2.27 | |
| >>SSB To Report List | | 0 . . . 1 | | SSB list to which the request |
| | | | | applies. |
| >>>SSB To Report Item | | 1 . . . | | |
| | | <maxnoof | | |
| | | SSBAreas> | | |
| >>>>SSB-Index | M | | INTEGER | |
| | | | (0 . . . , 63 . . . ) | |
| >>Slice To Report List | | 0 . . . 1 | | S-NSSAI list to which the request |
| | | | | applies. |
| >>>Slice To Report Item | | 1 . . . | | |
| | | <maxnoof | | |
| | | BPLMNs> | | |
| >>>>PLMN Identity | M | | 9.3.1.14 | Broadcast PLMN |
| >>>>S-NSSAI List | | 1 | | |
| >>>>>S-NSSAI Item | | 1 . . . | | |
| | | <maxnoof | | |
| | | SliceItems> | | |
| >>>>>>S-NSSAI | M | | S-NSSAI | |
| | | | 9.3.1.38 | |
| Reporting Periodicity | 0 | | ENUMERATED | Periodicity that can be used for |
| | | | (100 ms, 200 ms, | reporting of Traffic Status, |
| | | | 500 ms, 1 s, 2 s, | Predicted Traffic Status, Traffic |
| | | | 5 s, 10 s, . . . ) | Migration Indication. Also used |
| | | | | as the averaging window length |
| | | | | for all measurement object if |
| | | | | supported. |
| Prediction Period | 0 | | ENUMERATED | Period that can be used for |
| | | | (100 ms, 200 ms, | predicting of Predicted Traffic |
| | | | 500 ms, 1 s, 2 s, | Status. Also used as the |
| | | | 5 s, 10 s, . . . ) | averaging window length for all |
| | | | | measurement object if |
| | | | | supported. |

| Condition | Explanation |
|---|---|
| ifRegistrationRequestStoporAdd | This IE shall be present if the Registration Request IE is set to the value |
| | “stop” or “add”. |
| ifRegistrationRequestStart | This IE shall be present if the Registration Request IE is set to the value |
| | “start”. |
| Range bound | Explanation |
| maxnoofCellsinNG-RANnode | Maximum no. cells that can be served by a NG-RAN node. Value is 16384. |
| maxnoofSSBAreas | Maximum no. SSB coverage areas that can be served by a NG-RAN node |
| | cell. Value is 64. |
| maxnoofSliceItems | Maximum no. of signaled slice support items. Value is 1024. |

**End exemplary text for 3GPP TS 38.423**

Additionally, an example implementation of the third and fourth messages discussed above is given below for XnAP defined in 3GPP TS 38.423.
**Begin exemplary text for 3GPP TS 38.423**
9.1.3.X2 TRAFFIC STATUS RESPONSE
This message is sent by NG-RAN node₂ to NG-RAN node, to indicate that the requested measurement, for all or for a subset of the measurement objects included in the measurement is successfully initiated.
Direction: NG-RAN node 2 to NG-RAN node₁

| IE/Group Name | Presence | Range | IE type/ref. | Semantics description |
|---|---|---|---|---|
| Message Type | M | | 9.2.3.1 | |
| NG-RAN node₁ | M | | INTEGER | Allocated by NG-RAN node 1 |
| Measurement ID | | | (1 . . . 4095, . . . ) | |
| NG-RAN node₂ | M | | INTEGER | Allocated by NG-RAN node 2 |
| Measurement ID | | | (1 . . . 4095, . . . ) | |
| Criticality Diagnostics | O | | 9.2.3.3 | |

9.1.3.X3 TRAFFIC STATUS FAILURE
This message is sent by the NG-RAN node₂ to NG-RAN node, to indicate that for any of the requested measurement objects the measurement cannot be initiated.
Direction: NG-RAN node 2 to NG-RAN node 1

| IE/Group Name | Presence | Range | IE type/ref. | Semantics description |
|---|---|---|---|---|
| Message Type | M | | 9.2.3.1 | |
| NG-RAN node₁ | M | | INTEGER | Allocated by NG-RAN node 1 |
| Measurement ID | | | (1 . . . 4095, . . . ) | |
| NG-RAN node₂ | M | | INTEGER | Allocated by NG-RAN node 2 |
| Measurement ID | | | (1 . . . 4095, . . . ) | |
| Cause | M | | 9.2.3.2 | Ignored by the receiver when the |
| | | | | Complete Failure Cause Information |
| | | | | IE is included. |
| Criticality Diagnostics | O | | 9.2.3.3 | |

** End exemplary text for 3GPP TS 38.423***

Additionally, an example implementation of the first message discussed above is given below for XnAP defined in 3GPP TS 38.423.
*** Begin exemplary text for 3GPP TS 38.423**
9.1.3.X4 TRAFFIC STATUS UPDATE
This message is sent by NG-RAN node₂ to NG-RAN node₁ to report the results of the requested measurements.
Direction: NG-RAN node₂® NG-RAN node₁.

| IE/Group Name | Presence | Range | IE type/ref. | Semantics description |
|---|---|---|---|---|
| Message Type | M | | 9.2.3.1 | |
| NG-RAN node₁ | M | | INTEGER | Allocated by NG-RAN node₁ |
| Measurement ID | | | (1 . . . 4095, . . . ) | |
| NG-RAN node₂ | M | | INTEGER | Allocated by NG-RAN node₂ |
| Measurement ID | | | (1 . . . 4095, . . . ) | |
| Cell Measurement Result | | 1 | | |
| >Cell Measurement | | 1 . . . | | |
| Result Item | | <maxnoof | | |
| | | CellsinNG- | | |
| | | RANnode> | | |
| >>Cell ID | M | | Global NG-RAN | |
| | | | Cell Identity | |
| | | | 9.2.2.27 | |

The following IEs are additions to the above IEs currently specified in 3GPP TS 38.423.

| | | |
|---|---|---|
| >> Traffic Status | O | 9.2.2. Y1 |
| >> Predicted Traffic | O | 9.2.2. Y2 |
| Status | | |
| >> Traffic Migration | O | 9.2.2. Y3 |
| Indication | | |

| Range bound | Explanation |
|---|---|
| maxnoofCellsinNG-RANnode | Maximum no. cells that can be served by a NG-RAN node. Value is 16384. |

9.2.2.Y1 Traffic Status
The Traffic Status IE indicates the bitrate per cell and per SSB coverage area for all traffic in DL and UL.

| IE/Group Name | Presence | Range | IE type/ref. | Semantics description |
|---|---|---|---|---|
| CHOICE Traffic Status Type | M | | | |
| >ng-eNB | | | | |
| >>DL GBR Bitrate | M | | INTEGER | Per-cell DL GBR Bitrate |
| | | | (0 . . . 1E12) | |
| >>UL GBR Bitrate | M | | INTEGER | Per-cell UL GBR Bitrate |
| | | | (0 . . . 1E12) | |
| >>DL non-GBR Bitrate | M | | INTEGER | Per-cell DL non-GBR |
| | | | (0 . . . 1E12) | Bitrate |
| >>UL non-GBR Bitrate | M | | INTEGER | Per-cell UL non-GBR |
| | | | (0 . . . 1E12) | Bitrate |
| >>DL Total Bitrate | M | | INTEGER | Per-cell DL Total Bitrate |
| | | | (0 . . . 1E12) | |
| >>UL Total Bitrate | M | | INTEGER | Per-cell UL Total Bitrate |
| | | | (0 . . . 1E12) | |
| >gNB | | | | |
| >>SSB Area Traffic Status List | | 1 | | |
| >>>SSB Area Traffic Status Item | | 1 . . . < max | | |
| | | noofSSBAreas> | | |
| >>>>SSB Index | M | | INTEGER | |
| | | | (0 . . . 63) | |
| >>>>SSB Area DL GBR Bitrate | M | | INTEGER | Per-SSB area DL GBR |
| | | | (0 . . . 1E12) | Bitrate |
| >>>>SSB Area UL GBR Bitrate | M | | INTEGER | Per-SSB area UL GBR |
| | | | (0 . . . 1E12) | Bitrate |
| >>>>SSB Area DL non-GBR Bitrate | M | | INTEGER | Per-SSB area DL non-GBR |
| | | | (0 . . . 1E12) | Bitrate |
| >>>>SSB Area UL non-GBR Bitrate | M | | INTEGER | Per-SSB area UL non-GBR |
| | | | (0 . . . 1E12) | Bitrate |
| >>>>SSB Area DL Total Bitrate | M | | INTEGER | Per-SSB area DL Total |
| | | | (0 . . . 1E12) | Bitrate |
| >>>>SSB Area UL Total Bitrate | M | | INTEGER | Per-SSB area UL Total |
| | | | (0 . . . 1E12) | Bitrate |

| Range bound | Explanation |
|---|---|
| maxnoofSSBAreas | Maximum no. SSB coverage areas that can be served by a NG-RAN |
| | node cell. Value is 64. |

9.2.2.Y2 Predicted Traffic Status

| IE/Group Name | Presence | Range | IE type/ref. | Semantics description |
|---|---|---|---|---|
| CHOICE Traffic Status Type | M | | | |
| >ng-eNB | | | | |
| >>Predicted Uncertainty | M | | INTEGER | |
| | | | (0 . . . 100) | |
| >>DL GBR Bitrate | M | | INTEGER | Per-cell DL GBR Bitrate |
| | | | (0 . . . 1E12) | |
| >>UL GBR Bitrate | M | | INTEGER | Per-cell UL GBR Bitrate |
| | | | (0 . . . 1E12) | |
| >>DL non-GBR Bitrate | M | | INTEGER | Per-cell DL non-GBR Bitrate |
| | | | (0 . . . 1E12) | |
| >>UL non-GBR Bitrate | M | | INTEGER | Per-cell UL non-GBR Bitrate |
| | | | (0 . . . 1E12) | |
| >>DL Total Bitrate | M | | INTEGER | Per-cell DL Total Bitrate |
| | | | (0 . . . 1E12) | |
| >>UL Total Bitrate | M | | INTEGER | Per-cell UL Total Bitrate |
| | | | (0 . . . 1E12) | |
| >gNB | | | | |
| >>SSB Area Traffic Status List | | 1 | | |
| >>>SSB Area Traffic Status Item | | 1 . . . | | |
| | | <maxnoof | | |
| | | SSBAreas> | | |
| >>>>SSB Index | M | | INTEGER | |
| | | | (0 . . . 63) | |
| >>>>Predicted Uncertainty | M | | INTEGER | |
| | | | (0 . . . 100) | |
| >>>>SSB Area DL GBR Bitrate | M | | INTEGER | Per-SSB area DL GBR |
| | | | (0 . . . 1E12) | Bitrate |
| >>>>SSB Area UL GBR Bitrate | M | | INTEGER | Per-SSB area UL GBR |
| | | | (0 . . . 1E12) | Bitrate |
| >>>>SSB Area DL non-GBR Bitrate | M | | INTEGER | Per-SSB area DL non-GBR |
| | | | (0 . . . 1E12) | Bitrate |
| >>>>SSB Area UL non-GBR Bitrate | M | | INTEGER | Per-SSB area UL non-GBR |
| | | | (0 . . . 1E12) | Bitrate |
| >>>>SSB Area DL Total Bitrate | M | | INTEGER | Per-SSB area DL Total |
| | | | (0 . . . 1E12) | Bitrate |
| >>>>SSB Area UL Total Bitrate | M | | INTEGER | Per-SSB area UL Total |
| | | | (0 . . . 1E12) | Bitrate |

| Range bound | Explanation |
|---|---|
| maxnoofSSBAreas | Maximum no. SSB coverage areas that can be served by a NG-RAN |
| | node cell. Value is 64. |

9.2.2.Y3 Traffic Migration Indication
This IE indicates NG-RAN nodes, cells and SSB Areas targeted by predicted traffic.

| IE/Group Name | Presence | Range | IE type/ref. | Semantics description |
|---|---|---|---|---|
| Target NG-RAN Node List | | 1 | | NG-RAN nodes targeted by |
| | | | | predicted traffic |
| > Target NG-RAN Node Item | | 1 . . . | | |
| | | <maxnoofNG- | | |
| | | RANnode> | | |
| >> Global NG-RAN Node ID | M | | 9.2.2.3 | |
| >> Target NR Cell List | | 0 . . . 1 | | NR Cells targeted by |
| | | | | predicted traffic |
| >>> Target NR Cell Item | | 0 . . . | | |
| | | <maxnoof | | |
| | | CellsinNG- | | |
| | | RANnode> | | |
| >>>> NR CGI | M | | 9.2.2.7 | |
| >>>>> Target SSB Area List | | 0.1 | | SSB Areas targeted by |
| | | | | predicted traffic |
| >>>>>> Target SSB Area Item | | 1 . . . | | |
| | | <maxnoofSSB | | |
| | | Areas> | | |
| >>>>>>> SSB-Index | M | | INTEGER | |
| | | | (0 . . . , 63 . . . ) | |

| Range bound | Explanation |
|---|---|
| maxnoofTargetNG-RANnodes | Maximum no. target NG-RAN nodes. |
| | Value is 16. |
| maxnoofCellsinNG-RANnode | Maximum no. cells that can be served by an NG-RAN node. |
| | Value is 16384. |
| maxnoofSSBAreas | Maximum no. SSB Areas that can be served by a NG-RAN node cell. |
| | Value is 64. |

**End exemplary text for 3GPP TS 38.423**

Additionally, another example implementation of the first message discussed above can be (or be part of) a HANDOVER REQUEST message defined in 3GPP TS 38.423 (v16.5.0). In this implementation, the HANDOVER REQUEST message can include a PE Traffic Information IE. In some embodiments, the UE Traffic Information IE can include an OCTET STRING containing a UE's Traffic Status Report, which includes traffic status information reported from the UE such as described herein.

Alternatively, the UE Traffic Information IE may contain an explicit list of IEs of an application-level protocol, such as any interface protocol used for handover preparation procedures (e.g., XnAP, X2AP, NGAP, S1AP, etc.). The explicitly listed IEs represent information provided by the UE and form the Traffic Status report, such as a prediction of the data rate the UE may request in the future, or the prediction of the data volume the UE may request in the future. The following is exemplary text for 3GPP TS 38.423 (or any other appropriate 3GPP specification) that defines a UE Traffic Information IE according to this alternative.
***Begin exemplary text for 3GPP TS 38.423***
9.2.3.YY UE Traffic Information
This IE contains information about UE traffic.

| IE/Group Name | Pres. | Range | IE type/ref. | Semantics description |
|---|---|---|---|---|
| Traffic Status | M | | | Measured traffic status at |
| | | | | the UE |
| >DL GBR Bitrate | O | | INTEGER (0 . . . 1E12) | |
| >UL GBR Bitrate | O | | INTEGER (0 . . . 1E12) | |
| >DL non-GBR Bitrate | O | | INTEGER (0 . . . 1E12) | |
| >UL non-GBR Bitrate | O | | INTEGER (0 . . . 1E12) | |
| >DL Total Bitrate | M | | INTEGER (0 . . . 1E12) | |
| >UL Total Bitrate | M | | INTEGER (0 . . . 1E12) | |
| >UL Data Volume | O | | INTEGER (0 . . . 1E12) | |
| >DL Data Volume | O | | INTEGER (0 . . . 1E12) | |
| >UL Data Volume | O | | INTEGER (0 . . . 1E12) | |
| >Per S-NSSAI Traffic | O | | | Measured traffic status |
| Status | | | | per S-NSSAI at the UE |
| >>S-NSSAI List | | 0 . . . 1 | | |
| >>>S-NSSAI Item | | 1 . . . | | |
| | | <maxnoof | | |
| | | SliceItems> | | |
| >>>>S-NSSAI | | | | |
| >>>>>UL Total Bitrate | O | | INTEGER (0 . . . 1E12) | |
| >>>>>DL Total Bitrate | O | | INTEGER (0 . . . 1E12) | |
| Predicted Traffic Status | M | | | Predicted traffic status at |
| | | | | the UE |
| >DL GBR Bitrate | O | | INTEGER (0 . . . 1E12) | |
| >UL GBR Bitrate | O | | INTEGER (0 . . . 1E12) | |
| >DL non-GBR Bitrate | O | | INTEGER (0 . . . 1E12) | |
| >UL non-GBR Bitrate | O | | INTEGER (0 . . . 1E12) | |
| >DL Total Bitrate | M | | INTEGER (0 . . . 1E12) | |
| >UL Total Bitrate | | | INTEGER (0 . . . 1E12) | |
| >UL Data Volume | O | | INTEGER (0 . . . 1E12) | |
| >DL Data Volume | O | | INTEGER (0 . . . 1E12) | |
| >Per S-NSSAI Traffic | O | | | Predicted traffic status per |
| Status Prediction | | | | S-NSSAI at the UE |
| >>S-NSSAI List | | 0 . . . 1 | | |
| >>>S-NSSAI Item | | 1 . . . | | |
| | | <maxnoof | | |
| | | SliceItems> | | |
| >>>>S-NSSAI | | | | |
| >>>>>UL Total Bitrate | O | | INTEGER (0 . . . 1E12) | |
| >>>>>DL Total Bitrate | O | | INTEGER (0 . . . 1E12) | |
| >>Predicted Uncertainty | M | | INTEGER (0 . . . 100) | |

| Range bound | Explanation |
|---|---|
| maxnoofSliceltems | Maximum no. of signaled slice support items. Value is 1024. |

**End exemplary text for 3GPP TS 38.423**

Other embodiments of the present disclosure provide flexible and efficient signaling techniques for a network node (e.g., eNB, gNB, ng-eNB, etc.) to configure and/or request a UE to provide measurements and/or predictions of the UE's data traffic requirements, e.g., with respect to different applications and/or types of services. These embodiments can be used independent of the above-described embodiments. Alternately, various of these embodiments can be used and/or combined with the above-described embodiments in complementary ways that will be apparent to persons of ordinary skill.

Upon collecting predictions of the UE's data traffic requirements, the network node may use such information to optimize future network operation towards the UE, such as allocation of resources, configuration of measurements, preparation for handover, etc. Additionally, upon collecting predictions of the data traffic requirements from multiple UEs and combining such information with mobility-related information reported by the UEs, the network node can more reliably predict and/or estimate both traffic load and traffic mobility patterns in a relevant coverage area, e.g., one or more cells, one or more SSB beams, etc. Furthermore, the network can use such predictions and/or estimates to optimize and/or improve operations, such as by configuration of cells and/or beams to provide optimal coverage and capacity (e.g., via CCO), perform MLB and/or mobility setting changes, etc.

These embodiments of the present disclosure can provide various advantages, benefits, and/or solutions to problems. For example, the network node can improve configuration of, and/or resource allocation for, a UE so as to reduce UE energy consumption and/or improve QoS for applications and services run by the UE (e.g., via DRX and/or DTX cycles, carrier aggregation, multi-connectivity, RRC state settings, beam tracking, etc.). As another example, by combining information from multiple UEs, a network node can obtain a composite view of current data traffic and predicted future traffic in cells and/or beams, as well as for different applications and/or types of services. This information facilitates network node resource management, such as activating new cells or beam coverage areas, deactivating existing cells or beam coverage areas, configure UEs to improve spectral efficiency in a cell, etc.

Examples of algorithms that a UE could use to predict or estimate requested traffic state information may include traditional estimation methods (e.g., maximum likelihood, Minimum Square Error, Minimum Mean Square Error, Kalman filters, etc.) or artificial intelligence/machine learning (AI/ML)-based techniques such as supervised learning methods, deep learning algorithms, autoregression algorithms, etc. Some AI/ML algorithms may exploit functional approximation models, such as feedforward neural networks, deep neural networks, recurrent neural networks, convolutional neural networks, etc., which can be trained to estimate at least one traffic metric of interest based on prior data samples collected by the UE itself, by the UE manufacturer from multiple UEs, or by a network operator using data samples from multiple UEs served by its network.

Some embodiments include methods performed by a network node of a communication network (e.g., wireless network, RAN, etc.) for configuring a UE to report user related traffic state information associated with measurements and/or predictions. At a high level, these methods can include transmitting respective first messages to one or more UEs, each first message configuring and/or requesting a UE to provide UE traffic state information. These methods can also include receiving respective second messages from the one or more UEs, each second message comprising a UE traffic state report. These methods can also include optimizing one of more operation associated with the UE and/or to the network node based on the respective traffic state reports from the one or more UEs.

FIG. 8 shows a flow diagram that illustrates some of these embodiments, particularly for signaling between a network node (820) and a UE (810). Skilled persons will recognize that the signaling shown in FIG. 8 can be easily extended to multiple UEs, each receiving a first message from the network node and each sending a second message to the network node.

In various embodiments, the network node can optimize various operations based on a traffic state report from a particular UE, including handover preparation for the UE, allocation of time-frequency resources to serve the UE's traffic, activation/deactivation of secondary carriers for the UE, etc. In addition, based on traffic state reports from multiple UEs, the network node can predict and/or determine traffic, load, and/or mobility patterns for one or more serving cells or portions thereof, such as coverage area(s) of RS beam(s) (e.g., SSB coverage area, CSI-RS coverage area).

In various embodiments, based on such predictions, the network node can optimize various network operations such as configuration of cells and/or portions thereof (e.g., beam coverage area) to provide optimal coverage and capacity for the predicted traffic patterns in the network node's coverage area. Additionally, the network node may utilize aggregate predictions of traffic amount and/or traffic mobility patterns within coverage area to optimize mobility settings in relation to a further coverage area (e.g., neighbor cells) served by a second network node. One example is a trigger configuration for mobility (e.g., handover) between cells and/or portions thereof (e.g., beam coverage areas).

As another example, the network node can use traffic predictions (per UE or aggregated per coverage area) to obtain QoS predictions, by which it can optimize radio network configuration and trigger early actions to facilitate QoS fulfillment for the predicted upcoming traffic and/or provide QoS feedback to a core network (e.g., 5GC). As another example, the network node can use UE-provided traffic predictions in conjunction with its own aggregated and/or UE-specific traffic predictions to assign and/or classify served UEs to various network slices according to resource and slice partitioning policies.

As another example, the network can use the traffic predictions to optimize energy consumption of the UE(s), such as by adjusting paging configurations, DRX cycles, scheduled bandwidth parts (BWP), measurement configurations, etc. As a more specific example, the network node can use the traffic predictions to set RRC states for the respective UEs. Putting a UE into RRC_IDLE state increases the UE's latency for accessing various services, since the UE needs to perform additional signaling to return to RRC_CONNECTED state before accessing services. On the other hand, UE energy consumption can be reduced when operating in RRC_IDLE for a sufficient period of time.

Similarly, putting a UE into RRC_INACTIVE state also reduces UE energy consumption and increases latency for service access, but with less latency than operation in RRC_IDLE. Accordingly, if a second message from a UE includes a predicted time-to-next packet for the UE, the network can decide whether to change an RRC_CONNECTED UE to RRC_IDLE or RRC_INACTIVE. This change can be made, for example, if operating in the lower-energy state until the predicted arrival time of a next packet would result in some net energy reduction for the UE, when taking into account the UE's switching between states. Additionally, if the predicted time-to-next packet is accompanied by a prediction uncertainty, the network node can base this decision on an assumed UE lower-energy operation for a duration of time-to-next-packet minus the prediction uncertainty. In some cases, if the network node decides not to change the UE state based on the prediction, it can fallback to a legacy, timer-based switching procedure.

As another example, the network node can use the traffic predictions to optimize and/or improve beam tracking operation with the UE. From a beamforming point of view, it is good to have optimal beamforming vectors towards the UE when there is data to send to and/or receive from the UE. Once sending and/or receiving data is completed, however, optimal beamforming towards the UE is not needed. The process of the network node finding the beamforming vector to be used for data transmission towards the UE is often referred as “beam tracking”, which can be require a significant amount of radio resources and processing resources when done continuously. On the other hand, performing beam tracking only after UL data arrives in a UE's buffer introduces an extra data transmission delay, which can be very undesirable for certain services (e.g., URLLC). Accordingly, in some embodiments, the network node can selectively perform beam tracking for a UE based on information in the second message from the UE. For example, the network node can initiate beam tracking for the UE shortly before the UE's predicted arrival time of a next packet (i.e., provided in the second message). In this manner, the network node can reduce requirements on its radio resources and processing resources while minimizing and/or reducing any adverse effects on the UE's access to services.

In various embodiments, each first message can request and/or configure any of the following information from the recipient UE:
measurements of UE traffic state information, in DL and/or UL;
predictions of UE traffic state information, in DL and/or UL; and
prediction accuracy, e.g., per prediction or a single metric for all predicted information.

In some embodiments, the request and/or configuration of measurements and/or predictions of the UE's traffic state may comprise any of the following:
list of one or more service types for which traffic measurements and/or predictions are requested/configured;
list of Application Identifiers for which traffic measurements and/or predictions are requested/configured;
list of traffic measurement and/or prediction types requested/configured for each service type and/or for each user application;
traffic pattern information corresponding to one or more requested traffic measurement and/or predictions (e.g., per traffic type and/or per traffic application type); and
list of environmental information associated with the required/configured traffic measurements and/or predictions.

In some embodiments, the service types for which the network node may request or configure the UE to provide measurements and/or predictions of traffic can include any of the following: web browsing; feeds (e.g., news, trading, navigation); social media and/or networking; professional media; gaming (e.g., online gaming); streaming (e.g., progressive download, 3GP-DASH, video, audio, music, text, live video, live audio, web radio, social events, podcast); file transfer; audio call; video call; VoIP/VoLTE/ViLTE/VoNR/ViNR, Multimedia Telephony Service for IMS (MTSI); virtual reality; augmented reality; extended reality; real-time; non-real-time; vehicular (e.g., V2X); broadcasting (e.g., TV, radio); multicasting; surveillance and/or security-related; mobile Internet of Things (MIoT); Industrial IoT (IIoT); 3GP-DASH streaming; and URLLC.

In some embodiments, the network node may request and/or configure the UE to provide measurements and/or predictions of traffic on a per network slice basis, e.g., per S-NSSAI (specific network slice selection assistance information) as a slice identifier.

In some embodiments, the applications identifiers used by the network node to request or configure the UE to provide measurements and/or predictions of traffic may identify the applications and/or types of applications executed in the UE operating system. In this manner, the UE may be configured and/or requested to report traffic measurements and/or predictions for specific applications and/or application types, which would enable the network node to gain a richer insight of the user traffic source and/or the user traffic patterns.

In some embodiments, the first message may request or configure the UE to provide an indication of quality of service (QoS) associated with the service types and/or the application identifiers for which traffic measurements and/or predictions are required/configured. For example, the network node may request the UE to report traffic measurements and or traffic predictions for a service type related to social networking. As part of this service type, the user may generate different types of traffic with different QoS requirements, such as video call, video streaming, large file downloading, sporadic text messaging, etc. By providing the QoS associated with at least one portion of the traffic of the service type, the UE provides the network node with a richer insight of the user traffic source and/or the user traffic patterns.

In various embodiments, the type of traffic measurements and/or predictions that the first network node may request or configure the UE to provide can include any of the following:
average traffic measured and/or predicted with respect to one or more time intervals;
maximum or peak traffic measured or predicted with respect to one or more time intervals;
minimum traffic measured or predicted with respect to one or more time intervals;
at least a second statistical moment, such as the standard deviation and/or the variance, of traffic measured or predicted with respect to one or more time intervals;
aggregate traffic measured or predicted with respect to one or more time intervals;
indication of the average message and/or maximum/peak and/or minimum message/packet size measured or predicted with respect to one or more time intervals;
indication at least a statistical moment, such as standard deviation and/or variance, of the standard deviation of the message/packet size measured or predicted with respect to one or more time intervals;
indication of a predicted increase or decrease, e.g., a flag or a delta change, in the traffic with respect to one or more time intervals, current traffic, or previously reported measurement or prediction;
indication of the validity associated with one or more measurement or prediction of traffic;
indication of accuracy associated with one or more measurement or prediction of traffic;
indication pertaining a relevant time interval for the reported measurements or predictions;
type of the measurement or prediction to be a quantitative or qualitative type of predictions, e.g., if the first message includes an indication, indicating that qualitative prediction is requested, a classification type ML model/algorithm should be used by the UE;
indication that predicted average/max/min traffic is above a threshold value, where the threshold value can be indicated in the first message, e.g., the indication can comprise of a probability of being above the threshold such as a value between 0 and 1;
predicted bit rate requested within a given time window;
predicted data volume requested within a given time window;
predicted packet delay requested within a given time window;
predicted packet delay jitter requested within a given time window;
predicted packet error rate requested within a given time window;
predicted number of consecutive failed packed deliveries requested within a given time window;
predicted number of bursts in an application level message;
predicted application level message size;
predicted end-to-end latency;
predicted service downtime, namely a measure of maximum time during which the service can remain unserved (e.g., no packets can be transmitted for the service) without impacts on the target service quality;
predicted next packet arrival time.

In various embodiments, the first message may request or configure the UE to report one or more types of measurements and/or predictions of traffic state in any of the following formats:
absolute value represented of traffic, represented for instance, as number of bits, number of bytes, number of kilobits [kb], number of kilobytes [kB], number of megabits [Mb], number of megabits [MB], etc.;
number of packets with an associated packet size;
absolute vale representing throughput, service rate, or data rate, etc., such as in bits per second, bytes per seconds or scaled versions thereof (e.g., kilobits per second, kilobytes per second, etc.);
relative value or gap or offset with respect to a reference value of traffic such as maximum or minimum value of traffic.

In some embodiments, the first message may request or configure the UE to provide an indication of at least a predicted throughput, such as a prediction of throughput (service rate) that is expected from the network and/or prediction of throughput that is required/expected by UE to serve the UE's predicted traffic. Predictions of throughput could be expressed, for instance, in terms of average throughput, maximum throughput, minimum throughput, an offset with respect to a previously indicated throughput value.

In various embodiments, the traffic pattern information that the network node may request or configure the UE to provide an indication of whether the measured and/or predicted traffic is one of the following:
deterministic periodic traffic, or just periodic traffic;
deterministic aperiodic, or just aperiodic traffic;
regular or constant traffic; or
non-deterministic traffic.

The traffic pattern information can also indicate whether the traffic is uplink, downlink, or bidirectional. In case of periodic traffic, the network node may additionally request or configure the UE to provide additional information in case of periodic traffic, such as any of the following:
indication of the traffic periodicity;
indication of a time offset, e.g., with respect to the starting time of a measurement or prediction of a periodic traffic or with respect to the reporting time of a measurement/prediction of a periodic traffic;
offset with respect to the expected start time of a traffic session (e.g., in case of scheduled upload of some content);
indication of an expected start time or end time of a traffic session;
one or more indications of a time of the day where the traffic occurs, or it is expected to occur (in case of a prediction);
one or more indication of a location (e.g., GPS position, coverage area of a cell, SSB beam, etc.) wherein the traffic occurs, or it is expected to occur;
one or more indication of the duration of traffic demand (such as periodicity, elapse time, a flow duration, etc.);
indication of the destination associated the traffic demand; and
indication of whether the measurements and/or predictions of traffic are related to one or more network slice.

In some embodiments, the list of environmental information requested or configured to be reported (i.e., in a second message) in association to measurements and/or predictions of the UE traffic may include any of the following:
Identifier of serving cell where the UE is camping when the reported measurements and/or predictions or traffic are determined.
Identifier of at least one portion of the serving cell coverage area where the UE is camping when the reported measurements and/or predictions or traffic are determined. Examples may comprise the coverage area of reference signals beams transmitted by the network node within the coverage area of the serving cell where the UE is camping, such as SSB beams and/or CSI-RS beams. As an example, the UE can be requested or configured to report one or more SSB indices associated with measurements and/or predictions of the UE's traffic. As such, the reported measurements and/or predictions of traffic could further be associated with the coverage area of specific SSB beams within the serving cell.
Identifier of time at which the measurements and/or predictions of traffic are taken.
Indication of UE speed associated with the measurements and/or prediction of traffic.
Indication of UE position/location associated with the measurements and/or prediction of traffic. The position/location of the UE may comprise information related to a position in a 3-dimentional space (e.g., including azimuth).
Indication of UE orientation associated with the measurements and/or prediction of traffic.
Indication of positioning reference signals available to the UE when determining the measurements and/or prediction of traffic.

In some embodiments, the first message may include one or more instructions and/or configurations of how and/or when the UE should perform measurements and/or predictions of the UE traffic state information. The following is a non-exhaustive list of examples:
absolute time, relative time, or time interval during which measurements and/or predictions of the UE's traffic state information should be done. Examples may include:
   list of transmission time intervals (TTIs) at which traffic measurements and/or predictions should be taken;
   starting time, such as a staring TTI, radio frame, slot, etc. at which the measurements and/r prediction should be taken;
   ending time, such as an ending TTI, radio frame, slot etc. at which the measurements and/r prediction should be stopped;
   One or more periodicity over time (e.g., time periods) at which measurements and/or predictions should be taken; and
   One or more time-windows indicating the duration of the measurement and/or prediction of the UE's traffic state information.
validity time or validity time interval for measuring and/or predicting the UE's traffic state information;
maximum size for logging/storing measurements and/or predictions of the UE's traffic information;
sampling rate, indicating the time in between consecutive measurements and/or predictions of the UE's traffic state information;
filtering conditions pertaining to RRC states, RATs, slices, cells, carriers, tracking areas, PLMN, which can be used to include at least one of the above or exclude at least one of the above;
indication(s) of persistence of measuring and/or predicting of the UE's traffic state information through changes and/or updates to radio-related and/or non-radio-related configurations and/or operating conditions of the UE;
identity of one or more network node or cell towards which the measurements and/or predictions of the UE's traffic state information should/can be reported, such as a network node and/or a second network node, a first cell or a second cell;
indication to only measure and/or predict the UE's traffic state information when the UE is camped on/connected to/served by a network node;
indication to continue measuring and/or predicting of the UE's traffic state information during/after mobility to a second network node;
indication to continue measuring and/or predicting of the UE's traffic state information during/after a configuration/reconfiguration of dual connectivity operation;
indication to continue measuring and/or predicting of the UE's traffic state information upon/after (re)configuration of carrier aggregation in uplink/downlink, addition/removal of cells operating in unlicensed spectrum; and
indication to continue measuring and/or predicting of the UE's traffic state information upon/after updates of various configuration parameters. Non-limiting examples are: DRX configuration is updated, TDD configuration is changed.

In some embodiments, the first message may include one or more triggering conditions or indication to start, stop, pause, resume, or modify measuring and/or predicting at least part of the UE's traffic state information. The following is a non-exhaustive list of examples:
relative to a reference, such as:
   a maximum level, e.g., maximum power of the UE according to the UE power class, a maximum level of energy corresponding to said maximum power, etc.
   a maximum configured level (e.g., power, energy consumption, energy efficiency, etc.) associated with one of the RRC states (e.g., RRC_CONNECTED) for the UE;
   a minimum configured level (e.g., power, energy consumption, energy efficiency, etc.) associated with one of the RRC states (e.g., RRC_IDLE) for the UE;
   a configured (e.g., preferred or suggested) level (e.g., power, energy consumption, energy efficiency, etc.)
   a level (e.g., power, energy consumption, energy efficiency, etc.) that is substantially instantaneous or evaluated over a non-instantaneous past or future time interval.
at least one of the traffic state measurements and/or predictions (or its delta increase or decrease) is above a threshold, below a threshold, or between two thresholds;
at least one of the traffic state measurements and/or predictions (or its delta increase or decrease) is offset better (or worse) than a threshold;
at least one of the traffic state measurements and/or predictions (or its delta increase or decrease) is below a first threshold and at least traffic state measurement and/or prediction (or its delta increase or decrease) is above a second threshold; and
at least one of the traffic state measurements and/or predictions (or its delta increase or decrease) is above a first threshold and at least another traffic state measurement and/or prediction (or its delta increase or decrease) is below a second threshold.

In some embodiments, the first message may include one or more instructions and/or configurations of how and/or when the UE should report measurements and/or predictions of the UE traffic state information. The following is a non-exhaustive list of examples:
periodic or one-time reporting;
reporting upon a mobility event (e.g., together with or as part of a RRC Measurement Report, or as part of RRC Reconfiguration procedures, applied to one or more of intra-frequency, inter-frequency, inter-RAT, inter-system cases);
reporting upon (re)configuration of the UE Access Stratum (e.g., as part of RRC reconfiguration, or RRC re-establishment, or RRC resume procedures);
reporting upon network request;
reporting upon reaching a certain size for the logged/stored traffic state information;
reporting upon reaching a maximum size of the logged/stored traffic state information;
reporting upon change of the services provided by the application layer;
reporting when one of the measured and/or predicted traffic state information (or its delta increase or decrease) is above a threshold, below a threshold, between two thresholds, or an offset better or worse than a threshold;
reporting upon issuing a new or a modified configuration pertaining to the UE traffic state information, if a pre-existing configuration is available at the UE;
indication of whether reporting can be done opportunistically (e.g., only initiate reporting if radio coverage is above a certain threshold, or the battery level is not below a certain threshold);
indications of selective reporting based on certain conditions (e.g., not reporting when radio coverage is below a certain threshold);
indication of DRB or SRB to use for sending the report;
at least one of a list of filtering criteria to set the scope for measurements and/or predictions of the UE's traffic state information. Non-limiting examples can be: RRC states, RATs, network systems, S-NSSAIs, QoS parameters, service types, area scope, carrier frequencies;
indication to report the traffic state information to the network node while still connected to the network node;
indication to report log/stored traffic state information to a second network node (e.g., after mobility or after completion of (re)configuration of dual connectivity operation);
indication to log/store traffic state information and filtering criteria of the collected traffic state information that can be sent to a specific network node, e.g.:
   all logged/stored information can be sent to a network node, e.g., a RAN node, a CN node, an OAM node, an SMO node;
   report to a specific network node or to a specific cell, only the logged/stored information associated with the specific network node or the specific cell, while reporting to other network nodes or to other cells may be restricted completely or only to a portion of the collected traffic state information;
   report to a specific network node or to a specific cell, only the logged/stored information associated with a list of network nodes or a list of cells, while reporting to other network nodes or to other cells may be restricted completely or only to a portion of the collected traffic state information; and
   report to a specific network node or to a specific cell, only the portion of logged/stored information associated with network nodes or cells that satisfy certain conditions (e.g., a network node used as Serving Node, a network node used as Master Node, a PCell, a PSCell, etc.).

FIG. 9 shows a flow diagram that illustrates one or more example embodiments, particularly when the network node (920, a gNB in this case) transmits the first message as (or included in, as an IE) an RRCReconfiguration message defined in 3GPP TS 38.331 (v16.4.1). Additionally, FIG. 9 shows that the UE (910) transmits multiple second messages, e.g., as configured by the first message.

In various embodiments, the traffic state reports provided by the UE to the network node with the second messages may include measurements and/or predictions of the UE traffic state information as requested or configured by the first network node with the first message, including any of the examples discussed above.

In some embodiments, each second message sent by a UE and received by the network node may include a measurement object indicating one or more of the following:
list of one or more service types for which traffic measurements and/or predictions are provided;
list of Application Identifiers for which traffic measurements and/or predictions are provided;
one or more traffic measurements and/or predictions associated with each service type and/or application identifier and/or QoS flow for which measurements are provided; and
traffic pattern information associated with associated with each service type and/or for each user application and/or QoS flow for which measurements are provided.

Any of the examples of information requested or configured by the first message, discussed above, can be include in the traffic measurements and/or predictions or the traffic pattern information provided by the UE in the second message.

Other embodiments include methods performed by a UE operating in a communication network, for reporting user related traffic state information associated with measurements and/or predictions of the UE traffic. Such methods can be complementary to embodiments of the methods performed by the network node, discussed above. More specifically, the UE can receive a first message from a network node, the first message configuring and/or requesting the UE to provide traffic state information associated with the UE traffic. Additionally, the UE can transmit a second message to the network node, the second message comprising a traffic state report for the UE in accordance with the request or configuration of the first message.

In some embodiments, the UE can send the network node a capability indication, which can indicate whether the UE (e.g., UE upper protocol layers) is capable of performing traffic measurements and/or prediction needed to generate certain information requested by the first message and included in the second message. In some embodiments, the UE's capability indication can also indicate a type of algorithm (e.g., autoregressive, moving average, machine learning, etc.) the UE uses for such predictions.

As a more specific example, the capability indication can indicate whether the UE (e.g., UE upper protocol layers) can perform qualitative predictions, such as predicting traffic will be above or below certain configurable thresholds. For example, the UE could use a classification-based machine learning algorithm for such predictions.

As another more specific example, the capability indication can indicate whether the UE (e.g., UE upper protocol layers) can perform quantitative predictions, such as predicting traffic will be one of a set of predetermined integer values, with the respective integer values mapped to non-overlapping ranges of traffic amounts or rates (e.g., bytes, kilobytes, bits/second, kilobytes/second, etc.).

The UE can manage and perform the measurement and/or prediction needed to generate the contents of the second message in various ways. For example, upon receiving the first message as, or included in, an RRC message, the UE's RRC layer can send the message (or a configuration included therein) to an application layer, e.g., using an AT command. If the first message includes an application or service type identifier, the UE can use this information to select a destination (e.g., a particular application) on the application layer. The UE configures the RRC layer to receive the measured or predicted traffic values from the application layer (e.g., via AT command). Upon receiving such measurements and/or prediction performed by the application layer based on the configuration, the UE RRC layer sends a second message including such information.

As another example, if the configuration in the first message is for measurements and/or prediction of traffic across a range (e.g., all active) applications or service types, the UE can communicate with the various applications or services in the same manner as above, and then aggregate the information received from the respective services before reporting it in the second message. Alternately, the UE can measure and/or predict aggregated traffic within a protocol layer, such as PDCP.

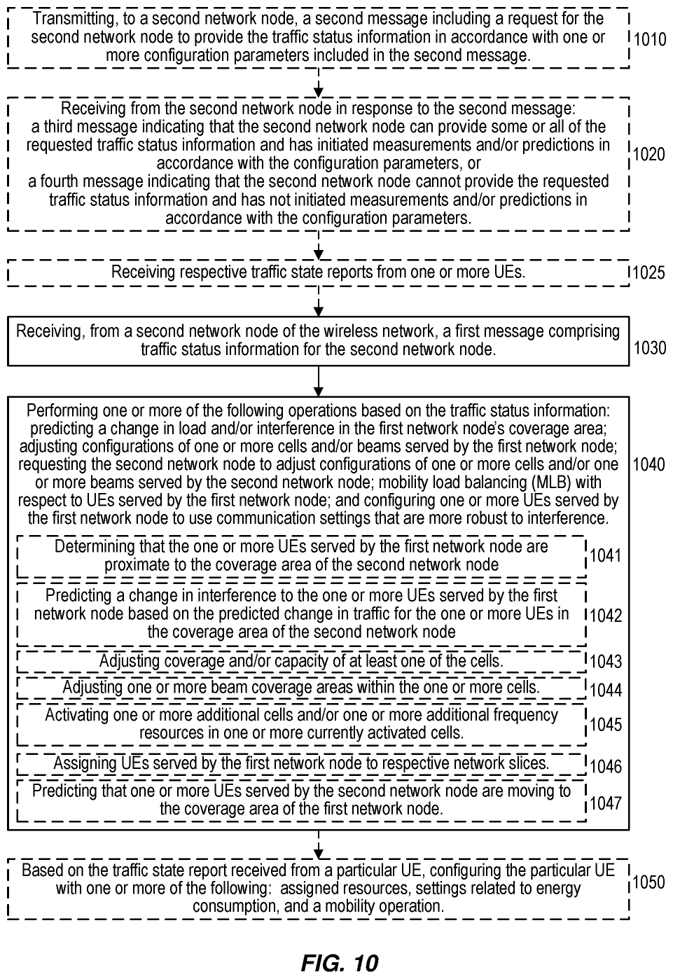

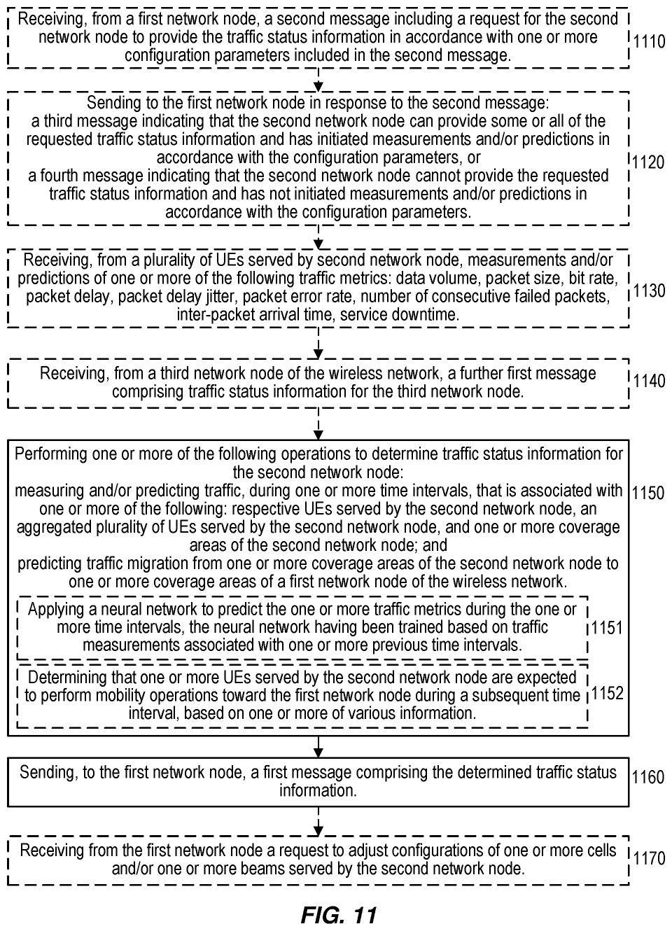

Various features of certain embodiments described above correspond to various operations illustrated in FIGS. 10-11, which show exemplary methods (e.g., procedures) for a first network node and a second network node, respectively. In other words, various features of the operations described below correspond to certain embodiments described above. Furthermore, the exemplary methods shown in FIGS. 10-11 can be used cooperatively to provide various benefits, advantages, and/or solutions to problems described herein. Although FIGS. 10-11 show specific blocks in particular orders, the operations of the exemplary methods can be performed in different orders than shown and can be combined and/or divided into blocks having different functionality than shown. Optional blocks or operations are indicated by dashed lines.

More specifically, FIG. 10 shows an exemplary method (e.g., procedure) for a first network node of a wireless network, according to various embodiments of the present disclosure. The exemplary method can be performed by a network node (e.g., base station, eNB, gNB, ng-eNB, etc.) such as described elsewhere herein.

The exemplary method can include the operations of block 1030, where the first network node can receive, from a second network node of the wireless network, a first message comprising traffic status information for the second network node. The exemplary method can also include the operations of block 1040, where the first network node can perform one or more of the following based on the traffic status information:
predicting a change (e.g., increase or decrease) in load and/or interference in a coverage area of the first network node;
adjusting configurations of one or more cells and/or one or more beams served by the first network node;
requesting the second network node to adjust configurations of one or more cells and/or one or more beams served by the second network node;
mobility load balancing (MLB) with respect to one or more UEs served by the first network node; and
configuring one or more UEs served by the first network node to use communication settings that are more robust to interference.

In some embodiments, the traffic status information for the second network node includes the following:
measurements and/or predictions of traffic during one or more time intervals, associated with one or more of the following: respective UEs served by the second network node, an aggregated plurality of UEs served by the second network node, and one or more coverage areas of the second network node (e.g., cells, SSB beam coverage areas, CSI-RS beam coverage areas); and
indication of predicted traffic migration from the one or more coverage areas of the second network node to one or more coverage areas of the first network node (e.g., cells, SSB beam coverage areas, CSI-RS beam coverage areas, etc.).
   Various examples of each of these are discussed in more detail above.

In some of these embodiments, the traffic status information for the second network node comprises respective subsets of traffic status information. The respective subsets relate to different ones of any of the following associated with the second network node: cell, beam coverage area, RS coverage area, network slice, tracking area, PLMN, frequency range, transmission point, and resource type.

In some of these embodiments, the traffic status information for the second network node also includes indications of one or more of the following:
accuracy, precision, stability, validity, reliability, precision, and/or uncertainty of the measurements and/or predictions;
the one or more time intervals; and
locations of one or more UEs for which traffic status information is reported.

In some of these embodiments, the traffic status information includes one or more of the following traffic metrics: data volume, number of UEs, packet size, bit rate, packet delay, packet delay jitter, packet error rate, number of consecutive failed packets, inter-packet arrival time, service downtime, number of bursts in an application level message, application level message size, end-to-end latency. In some variants, each traffic metric is represented as one of the following, for each time interval:
one or more statistics including average, maximum, minimum, standard deviation, and variance;
a total or aggregate amount; and
predicted change with respect to current traffic, a previous time interval, or a previously reported measurement or prediction.

In some embodiments, the indication of predicted traffic migration (e.g., included in the traffic status information for the second network node) includes a plurality of traffic amounts, with each traffic amount being associated with a different combination of a coverage area of the second network node and a coverage area of the first network node.

In some embodiments, the first message is a handover request for a particular UE served by the second network node and the traffic status information includes one or more of the following: measurements of traffic for the particular UE during one or more previous time intervals, and predictions of traffic for the particular UE during one or more future time intervals.

In some embodiments, the exemplary method can also include the operations of blocks 1010-1020. In block 1010, the first network node can transmit, to the second network node, a second message including a request for the second network node to provide the traffic status information in accordance with one or more configuration parameters included in the second message. In block 1020, the first network node can receive one of the following from the second network node in response to the second message:
a third message indicating that the second network node can provide some or all of the requested traffic status information and has initiated measurements and/or predictions in accordance with the configuration parameters; or
a fourth message indicating that the second network node cannot provide the requested traffic status information and has not initiated measurements and/or predictions in accordance with the configuration parameters.

In some of these embodiments receiving the first message (e.g., in block 1030) is conditioned upon receiving the third message. In some of these embodiments, the one or more configuration parameters in the second message include indications of one or more of the following for which traffic status information is requested:
one or more network slices;
one or more service types;
one or more resource types;
one or more coverage areas of the second network node;
one or more coverage areas of the first network node;
one or more traffic metrics;
one or more time intervals; and
one or more thresholds for accuracy, precision, stability, validity, reliability, precision, and/or uncertainty of the measurements and/or predictions.

In some of these embodiments, the one or more configuration parameters include indications of one or more of the following:
one or more reporting formats;
one or more triggering conditions for obtaining the requested traffic status information; and
one or more triggering conditions for reporting the requested traffic status information.

In some embodiments, the traffic status information for the second network node (e.g., received in block 1030) includes a prediction of a change (e.g., increase) in traffic for one or more UEs in a coverage area of the second network node. In such case, predicting a change in interference in the coverage area of the first network node in block 1040 includes the following operations, denoted with corresponding sub-block numbers:
(1041) determining that the one or more UEs served by the first network node are proximate to the coverage area of the second network node; and
(1042) predicting a change in interference to the one or more UEs served by the first network node based on the predicted change in traffic for the one or more UEs in the coverage area of the second network node; and
   In such embodiments, the one or more UEs served by the first network node are configured in block 1040 to use more robust communication settings based on the predicted change in interference.

In some embodiments, adjusting configurations of one or more cells and/or one or more beams based on the traffic status information in block 1040 includes one or more of the following operations, denoted by corresponding sub-block numbers:
(1043) adjusting coverage and/or capacity of at least one of the cells;
(1044) adjusting one or more beam coverage areas within the one or more cells;
(1045) activating one or more additional cells and/or one or more additional frequency resources in one or more currently activated cells; and
(101046) assigning one or more UEs served by the first network node to respective network slices.

In some of these embodiments, predicting a change in load in a coverage area of the first network node in block 1040 includes the operations of block 1047, where the first network node can predict that one or more UEs served by the second network node are moving to the coverage area of the first network node. In such case, activating the one or more additional cells and/or the one or more additional frequency resources in sub-block 1045 is responsive to predicting that the one or more UEs served by the second network node are moving to the coverage area of the first network node, e.g., as performed in sub-block 1047.

In some embodiments, the exemplary method can also include the operations of block 1025, where the first network node can receive respective traffic state reports from one or more UEs. In such embodiments, performing the one or more operations in block 1040 is further based on an aggregation of the received traffic state reports. In some of these embodiments, the exemplary method can also include the operations of block 1050, where based on the traffic state report received from a particular UE, the first network node can configure the particular UE with one or more of the following: assigned resources, settings related to energy consumption, and a mobility operation.

In addition, FIG. 11 shows an exemplary method (e.g., procedure) for a second network node of a wireless network, according to various embodiments of the present disclosure. The exemplary method can be performed by a network node (e.g., base station, eNB, gNB, ng-eNB, etc.) such as described elsewhere herein.

The exemplary method can include the operations of block 1150, where the second network node can perform one or more of the following operations to determine traffic status information for the second network node:
measuring and/or predicting traffic, during one or more time intervals, that is associated with one or more of the following: respective UEs served by the second network node, an aggregated plurality of UEs served by the second network node, and one or more coverage areas of the second network node (e.g., cells, SSB beam coverage areas, CSI-RS beam coverage areas, etc.); and
predicting traffic migration from the one or more coverage areas of the second network node to one or more coverage areas of a first network node of the wireless network (e.g., cells, SSB beam coverage areas, CSI-RS beam coverage areas, etc.).

The exemplary method can also include the operations of block 1160, where the second network node can send, to the first network node, a first message comprising the determined traffic status information.

In some embodiments, the traffic status information for the second network node comprises respective subsets of traffic status information. The respective subsets relate to different ones of any of the following associated with the second network node: cell, beam coverage area, RS coverage area, network slice, tracking area, PLMN, frequency range, transmission point, and resource type.

In some embodiments, the traffic status information for the second network node can also include indication of one or more of the following:
accuracy, precision, stability, validity, reliability, precision, and/or uncertainty of the measurements and/or predictions;
the one or more time intervals; and
locations of one or more UEs for which traffic status information is reported.

In some embodiments, the traffic status information for the second network node includes one or more of the following traffic metrics: data volume, number of UEs, packet size, bit rate, packet delay, packet delay jitter, packet error rate, number of consecutive failed packets, inter-packet arrival time, service downtime, number of bursts in an application level message, application level message size, end-to-end latency. In some of these embodiments, each traffic metric is represented as one of the following, for each time interval:
one or more statistics including average, maximum, minimum, standard deviation, and variance;
a total or aggregate amount; and
predicted change with respect to current traffic, a previous time interval, or a previously reported measurement or prediction.

In some of these embodiments, predicting traffic during the one or more time intervals in block 1150 includes the operations of sub-block 1151, where the second network node can apply a neural network to predict the one or more traffic metrics during the one or more time intervals, with the neural network having been trained based on traffic measurements associated with one or more previous time intervals.

In some embodiments, the indication of predicted traffic migration includes a plurality of traffic amounts, with each traffic amount being associated with a different combination of a coverage area of the second network node and a coverage area of the first network node.

In some embodiments, the first message is a handover request for a particular UE served by the second network node and the traffic status information includes one or more of the following: measurements of traffic for the particular UE during one or more previous time intervals, and predictions of traffic for the particular UE during one or more future time intervals.

In some embodiments, the exemplary method can also include the operations of blocks 1110-1120. In block 1110, the second network node can receive, from the first network node, a second message including a request for the second network node to provide the traffic status information in accordance with one or more configuration parameters included in the second message. In block 1120, the second network node can send one of the following to the first network node in response to the second message:
a third message indicating that the second network node can provide some or all of the requested traffic status information and has initiated measurements and/or predictions in accordance with the configuration parameters; or
a fourth message indicating that the second network node cannot provide the requested traffic status information and has not initiated measurements and/or predictions in accordance with the configuration parameters.

In some of these embodiments receiving the first message (e.g., in block 1160) is responsive to sending the third message. In some of these embodiments, the one or more configuration parameters (in the second message) include indications of one or more of the following for which traffic status information is requested:
one or more network slices;
one or more service types;
one or more resource types;
one or more coverage areas of the second network node;
one or more coverage areas of the first network node;
one or more traffic metrics;
one or more time intervals; and
one or more thresholds for accuracy, precision, stability, validity, reliability, precision, and/or uncertainty of the measurements and/or predictions.

In some of these embodiments, the one or more configuration parameters (in the second message) include indications of one or more of the following:
one or more reporting formats;
one or more triggering conditions for obtaining the requested traffic status information; and
one or more triggering conditions for reporting the requested traffic status information.

In some embodiments, the exemplary method can also include the operations of block 1130, where the second network node can receive, from a plurality of UEs served by second network node, measurements and/or predictions of one or more of the following traffic metrics: data volume, packet size, bit rate, packet delay, packet delay jitter, packet error rate, number of consecutive failed packets, inter-packet arrival time, service downtime, number of bursts in an application level message, application level message size, end-to-end latency. In such embodiments, measuring and/or predicting the traffic for the second network node during the one or more time intervals in block 1150 is based on the measurements and/or predictions received from the plurality of UEs in block 1130.

In some embodiments, predicting traffic migration from one or more coverage areas of the second network node to one or more coverage areas of the first network node in block 1150 can include the operations of sub-block 1151, where the second network node can determine that one or more UEs served by the second network node are expected to perform mobility operations toward the first network node during a subsequent time interval, based on one or more of the following:
UE position, orientation, and/or speed information determined by the second network node;
UE position, orientation, and/or speed information reported by the respective UEs;
serving cell and/or neighbor cell measurements reported by the respective UEs;
indication of predicted traffic migration from one or more coverage areas of a third network node to one or more coverage areas of the second network node; and
historical UE mobility patterns in the coverage areas in which the one or more UEs are located.

In some embodiments, the exemplary method can also include the operations of block 1140, where the second network node can receive, from a third network node of the wireless network, a further first message comprising traffic status information for the third network node. The traffic status information for the second network is determined in block 1150 based on traffic status information for the third network node received in block 1140.

In some embodiments, the exemplary method can also include the operations of block 1170, where in response to sending the first message comprising the determined traffic status information in block 1160, the second network node can receive from the first network node a request to adjust configurations of one or more cells and/or one or more beams served by the second network node.

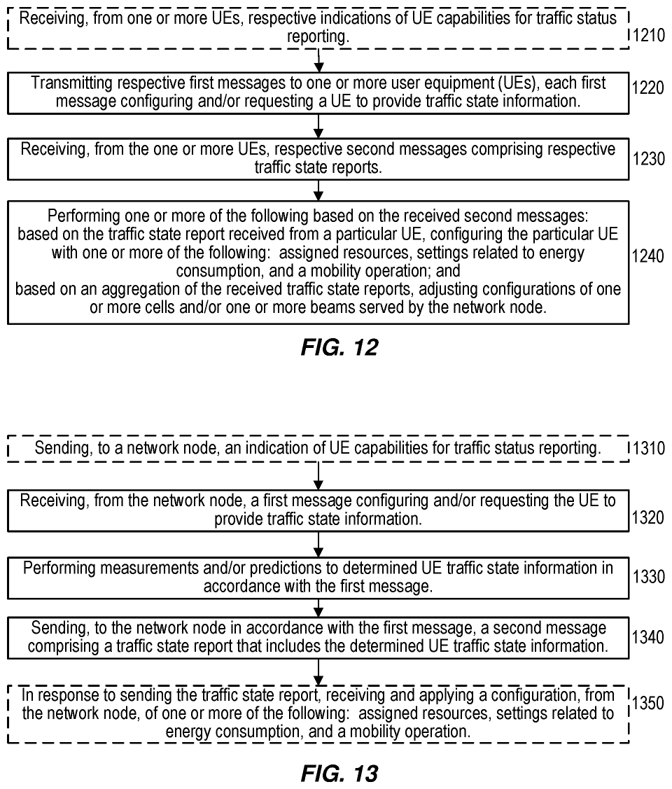

Various features of other embodiments described above correspond to various operations illustrated in FIGS. 12-13, which show exemplary methods (e.g., procedures) for a network node and a UE, respectively. In other words, various features of the operations described below correspond to certain other embodiments described above. Furthermore, the exemplary methods shown in FIGS. 12-13 can be used cooperatively to provide various benefits, advantages, and/or solutions to problems described herein. Although FIGS. 12-13 show specific blocks in particular orders, the operations of the exemplary methods can be performed in different orders than shown and can be combined and/or divided into blocks having different functionality than shown. Optional blocks or operations are indicated by dashed lines.

In particular, FIG. 12 shows an exemplary method (e.g., procedure) for a network node of a wireless network, according to various embodiments of the present disclosure. The exemplary method can be performed by a network node (e.g., base station, eNB, gNB, ng-eNB, etc.) such as described elsewhere herein.

The exemplary method can include the operations of block 1220, where the network node can transmit respective first messages to one or more UEs, each first message configuring and/or requesting a UE to provide traffic state information. The exemplary method can also include the operations of block 1230, where the network node can receive, from the one or more UEs, respective second messages comprising respective traffic state reports. The exemplary method can also include the operations of block 1240, where the network node can perform one or more of the following based on the received second messages:
based on the traffic state report received from a particular UE, configuring the particular UE with one or more of the following: assigned resources, settings related to energy consumption, and a mobility operation; and
based on an aggregation of the received traffic state reports, adjusting configurations of one or more cells and/or one or more beams served by the network node.

In some embodiments, the exemplary method can also include the operations of block 1210, where the network node can receive, from the one or more UEs, respective indications of UE capabilities for traffic status reporting. In such embodiments, the respective first messages are based on the respective UE capabilities.

In some embodiments, each first message includes identifiers of one or more of the following associated with the requested traffic state information:
one or more network slices for which measurements and/or predictions are requested from the receiving UE;
one or more service types for which measurements and/or predictions are requested from the receiving UE (e.g., as a list of one or more service types for which traffic measurements and/or predictions are requested/configured);
one or more applications for which measurements and/or predictions are requested from the receiving UE (e.g., as a list of Application Identifiers for which traffic measurements and/or predictions are requested/configured);
one or more types of traffic measurements and/or predictions requested for each identified application, service type, or network slice (e.g., as a list of traffic measurement and/or prediction types requested/configured for each service type and/or for each user application);
one or more traffic pattern types for which the identified traffic measurements and/or predictions are requested; and
one or more environmental conditions associated with the identified traffic measurements and/or predictions.

Various examples of each of these are discussed in more detail above.

In some embodiments, each first message can also include indications of one or more of the following:
one or more accuracies, each accuracy associated with a different portion of the requested traffic measurements and/or predictions (e.g., one accuracy associated with some or all, respective accuracies for each, etc.);
quality of service (QoS) information associated with traffic on which the requested traffic measurements and/or predictions should be performed;
one or more reporting formats for the requested traffic measurements and/or predictions;
one or more triggering conditions for performing the requested traffic measurements and/predictions; and
one or more triggering conditions for reporting the requested traffic measurements and/predictions.

Various examples of each of these are discussed in more detail above. In some of these embodiments, the requested reporting formats include any of the following: absolute value, scaled absolute value, relative to a reference value, count, index to a table of values.

In some embodiments, the identified environmental conditions can include any of the following: one or more serving cells, one or more beams, one or more positioning reference signals, a geographic location, a UE speed, a UE orientation, a time, a time period.

In some embodiments, the identified traffic pattern types can include any of the following: periodic, deterministic periodic, non-deterministic periodic, aperiodic, deterministic aperiodic, non-deterministic periodic, constant, regular, uplink, downlink, and bidirectional.

In some embodiments, the identified types of traffic measurements and/or predictions include any of the following:
average, maximum, minimum, standard deviation, and/or variance of one or more traffic metrics during one or more time intervals;
total or aggregate of one or more traffic metrics during one or more time intervals;
predicted change of one or more traffic metrics with respect to current traffic, a previous time interval, or a previously reported traffic measurement or prediction; and
quantitative or qualitative.

In some of these embodiments, the one or more traffic metrics include any of the following: service rate, throughput, packet size, bit rate, data volume, packet delay, packet delay jitter, packet error rate, number of consecutive failed packets, inter-packet arrival time, next packet arrival time, number of bursts in an application level message, application level message size, end-to-end latency, service downtime.

In some embodiments, each traffic state report can include measurements and/or predictions of traffic state information by a particular UE in accordance with the first message sent to the particular UE. Additionally, each traffic state report can include identifiers of one or more of the following associated with the measurements and/or predictions: one or more service types; one or more applications; one or more traffic pattern types; one or more accuracies; one or more quality of service (QoS) information; one or more prediction algorithms.

In some embodiments, configuring a particular UE based on the traffic state report received from the particular UE (e.g., in block 1240) can include one or more of the following:
selectively configuring the particular UE to operate in a non-connected state based on a predicted arrival time of a next packet; and
selectively performing beam tracking for the particular UE based on a predicted arrival time of a next packet.

More detailed examples of these selective operations were discussed above.

In some embodiments, adjusting configurations of one or more cells and/or one or more beams based on an aggregation of the received traffic state reports (e.g., in block 1240) can include one or more of the following:
adjusting coverage and/or capacity of at least one of the cells;
adjusting one or more beam coverage areas within the one or more cells;
assigning the UEs to respective network slices;
adjusting mobility settings with respect to one or more neighbor cells served by another network node; and
providing aggregated QoS information to a core network.

More detailed examples of these operations were discussed above.

In addition, FIG. 13 shows an exemplary method (e.g., procedure) for a UE operating in a wireless network, according to various embodiments of the present disclosure. The exemplary method can be performed by a UE (e.g., wireless device, IoT device, etc.) such as described elsewhere herein.

The exemplary method can include the operations of block 1320, where the UE can receive, from a network node, a first message configuring and/or requesting the UE to provide traffic state information. The exemplary method can also include the operations of block 1330, where the UE can perform measurements and/or predictions to determine UE traffic state information in accordance with the first message. The exemplary method can also include the operations of block 1340, where the UE can send, to the network node in accordance with the first message, a second message comprising a traffic state report that includes the determined UE traffic state information.

In some embodiments, the exemplary method can also include the operations of block 1310, where the UE can send, to the network node, an indication of UE capabilities for traffic status reporting. In such embodiments, the first message is based on the indicated UE capabilities.

In some embodiments, the first message includes identifiers of one or more of the following associated with the requested traffic state information:
one or more network slices for which measurements and/or predictions are requested from the UE;
one or more service types for which measurements and/or predictions are requested from the UE;
one or more applications for which measurements and/or predictions are requested from the UE;
one or more types of traffic measurements and/or predictions requested for each identified application, service type, or network slice;
one or more traffic pattern types for which the identified traffic measurements and/or predictions are requested; and
one or more environmental conditions associated with the identified traffic measurements and/or predictions.

Various examples of each of these are discussed in more detail above.

In some embodiments, each first message can also include indications of one or more of the following:
one or more accuracies, each accuracy associated with a different portion of the requested traffic measurements and/or predictions (e.g., one accuracy associated with some or all, respective accuracies for each, etc.);
QoS information associated with traffic on which the requested traffic measurements and/or predictions should be performed;
one or more reporting formats for the requested traffic measurements and/or predictions;
one or more triggering conditions for performing the requested traffic measurements and/predictions; and
one or more triggering conditions for reporting the requested traffic measurements and/predictions.

Various examples of each of these were discussed in more detail above. In some of these embodiments, the requested reporting formats can include any of the following: absolute value, scaled absolute value, relative to a reference value, count, index to a table of values.

In some embodiments, the identified traffic pattern types can include any of the following: periodic, deterministic periodic, non-deterministic periodic, aperiodic, deterministic aperiodic, non-deterministic periodic, constant, regular, uplink, downlink, bidirectional.

In some embodiments, the identified environmental conditions can include any of the following: one or more serving cells, one or more beams, one or more positioning reference signals, a geographic location, a UE speed, a UE orientation, a time, a time period.

In some embodiments, the identified types of traffic measurements and/or predictions include any of the following:
average, maximum, minimum, standard deviation, and/or variance of one or more traffic metrics during one or more time intervals;
total or aggregate of one or more traffic metrics during one or more time intervals;
predicted change of one or more traffic metrics with respect to current traffic, a previous time interval, or a previously reported traffic measurement or prediction; and
quantitative or qualitative.

In some of these embodiments, the one or more traffic metrics include any of the following: service rate, throughput, packet size, bit rate, data volume, packet delay, packet delay jitter, packet error rate, number of consecutive failed packets, inter-packet arrival time, next packet arrival time, number of bursts in an application level message, application level message size, end-to-end latency, service downtime.

In some embodiments, the traffic state report can also include identifiers of one or more of the following associated with the measurements and/or predictions: one or more service types; one or more applications; one or more traffic pattern types; one or more accuracies; one or more quality of service (QoS) information; one or more prediction algorithms.

In some embodiments, the exemplary method can also include the operations of block 1350, where the UE can, in response to sending the traffic state report (e.g., in block 1340), receive and apply a configuration, from the network node, of one or more of the following: assigned resources, settings related to energy consumption, and a mobility operation.

In some of these embodiments, the traffic state report includes a predicted arrival time of a next packet. In such embodiments, applying a configuration of settings related to energy consumption (e.g., in block 1350) can include the operations of sub-block 1351, where the UE can operate in a non-connected state until proximately before the predicted arrival time of the next packet. An example of such embodiments is described in more detail above.

In some embodiments, the first message is received and the second message is sent by an access layer of the UE (e.g., RRC layer). In such embodiments, the first message includes a configuration for measurements and/or prediction of data traffic associated with a first application hosted by the UE. Additionally, performing measurements and/or predictions to determine UE traffic state information in block 1330 can include the following operations, which can be considered sub-blocks 1331-1333:
sending the configuration from the access layer to an application layer of the UE;
performing, by the application layer according to the configuration, the measurements and/or predictions on data traffic associated with the first application; and
sending the measurements and/or predictions from the application layer to the access layer.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

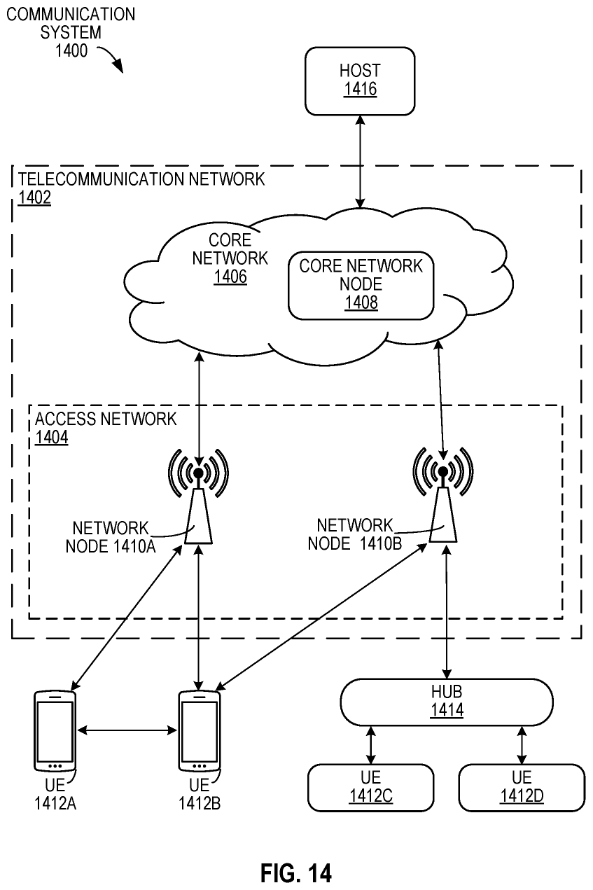

FIG. 14 shows an example of a communication system 1400 in accordance with some embodiments. In this example, the communication system 1400 includes a telecommunication network 1402 that includes an access network 1404, such as a radio access network (RAN), and a core network 1406, which includes one or more core network nodes 1408. The access network 1404 includes one or more access network nodes, such as network nodes 1410a and 1410b (one or more of which may be generally referred to as network nodes 1410), or any other similar 3GPP access node or non-3GPP access point. The network nodes 1410 facilitate direct or indirect connection of UEs, such as by connecting UEs 1412a, 1412b, 1412c, and 1412d (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, including wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1402 is a cellular network that implements 3GPP standardized features. Accordingly, the telecommunications network 1402 may support network slicing to provide different logical networks to different devices that are connected to the telecommunication network 1402. For example, the telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1414 communicates with the access network 1404 to facilitate indirect communication between one or more UEs (e.g., UE 1412c and/or 1412d) and network nodes (e.g., network node 1410b). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a VR headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410b. The hub 1414 may also allow for a different communication scheme and/or schedule between the hub 1414 and UEs (e.g., UE 1412c and/or 1412d), and between the hub 1414 and the core network 1406. In other examples, the hub 1414 is connected to the core network 1406 and/or one or more UEs via a wired connection. Moreover, the hub 1414 may be configured to connect to an M2M service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410b. In other embodiments, the hub 1414 may be a non-dedicated hub—that is, a device which is capable of operating to route communications between the UEs and network node 1410b, but which is additionally capable of operating as a communication start and/or end point for certain data channels.

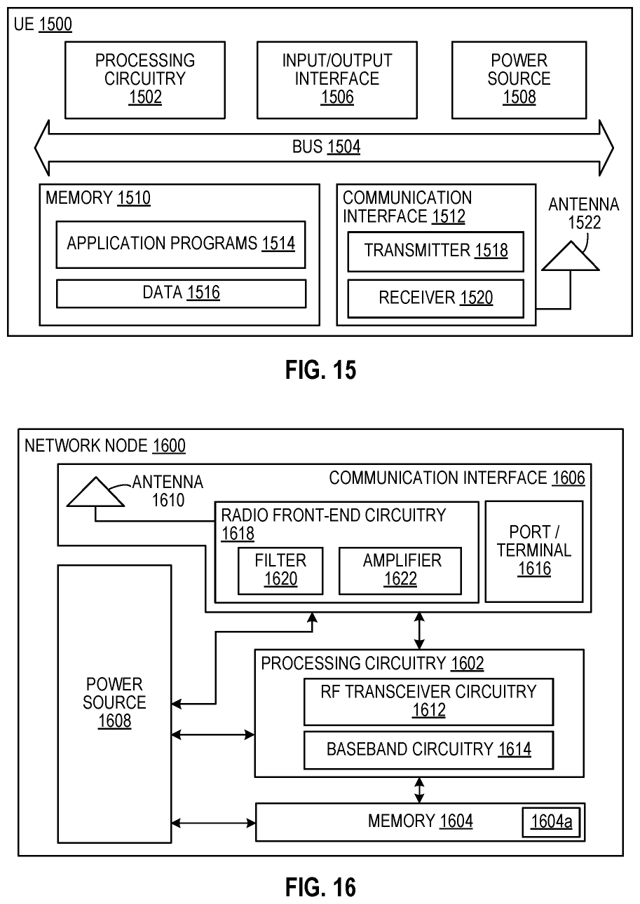

FIG. 15 shows a UE 1500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1500 includes processing circuitry 1502 that is operatively coupled via a bus 1504 to an input/output interface 1506, a power source 1508, a memory 1510, a communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1502 may include multiple central processing units (CPUs).

In the example, the input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g., an electricity outlet), photovoltaic device, or power cell, may be used. The power source 1508 may further include power circuitry for delivering power from the power source 1508 itself, and/or an external power source, to the various parts of the UE 1500 via input circuitry or an interface such as an electrical power cable. Delivering power may be, for example, for charging of the power source 1508. Power circuitry may perform any formatting, converting, or other modification to the power from the power source 1508 to make the power suitable for the respective components of the UE 1500 to which power is supplied.

The memory 1510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the UE 1500, any of a variety of various operating systems or combinations of operating systems.

The memory 1510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1510 may allow the UE 1500 to access instructions, application programs and the like, stored on transitory or non-transitory memory media, to off-load data, or to upload data. An article of manufacture, such as one utilizing a communication system may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g., another UE or a network node in an access network). Each transceiver may include a transmitter 1518 and/or a receiver 1520 appropriate to provide network communications (e.g., optical, electrical, frequency allocations, and so forth). Moreover, the transmitter 1518 and receiver 1520 may be coupled to one or more antennas (e.g., antenna 1522) and may share circuit components, software or firmware, or alternatively be implemented separately.

In the illustrated embodiment, communication functions of the communication interface 1512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1500 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 16 shows a network node 1600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1600 includes a processing circuitry 1602, a memory 1604, a communication interface 1606, and a power source 1608. The network node 1600 may be composed of multiple physically separate components (e.g., a NodeB component and a RNC component, or a BTS component and a BSC component, etc.), which may each have their own respective components. In certain scenarios in which the network node 1600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1600 may be configured to support multiple radio access technologies (RATs). In such embodiments, some components may be duplicated (e.g., separate memory 1604 for different RATs) and some components may be reused (e.g., a same antenna 1610 may be shared by different RATs). The network node 1600 may also include multiple sets of the various illustrated components for different wireless technologies integrated into network node 1600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1600.

The processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1600 components, such as the memory 1604, to provide network node 1600 functionality.

In some embodiments, the processing circuitry 1602 includes a system on a chip (SOC). In some embodiments, the processing circuitry 1602 includes one or more of radio frequency (RF) transceiver circuitry 1612 and baseband processing circuitry 1614. In some embodiments, the radio frequency (RF) transceiver circuitry 1612 and the baseband processing circuitry 1614 may be on separate chips (or sets of chips), boards, or units, such as radio units and digital units. In alternative embodiments, part or all of RF transceiver circuitry 1612 and baseband processing circuitry 1614 may be on the same chip or set of chips, boards, or units.

The memory 1604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions (referred to collectively as computer program product 1604a) capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and memory 1604 is integrated.

The communication interface 1606 is used in wired or wireless communication of signaling and/or data between a network node, access network, and/or UE. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. Radio front-end circuitry 1618 comprises filters 1620 and amplifiers 1622. The radio front-end circuitry 1618 may be connected to an antenna 1610 and processing circuitry 1602. The radio front-end circuitry may be configured to condition signals communicated between antenna 1610 and processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of filters 1620 and/or amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface may comprise different components and/or different combinations of components.

In certain alternative embodiments, the network node 1600 does not include separate radio front-end circuitry 1618, instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes one or more ports or terminals 1616, the radio front-end circuitry 1618, and the RF transceiver circuitry 1612, as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, communication interface 1606, and/or the processing circuitry 1602 may be configured to perform any receiving operations and/or certain obtaining operations described herein as being performed by the network node. Any information, data and/or signals may be received from a UE, another network node and/or any other network equipment. Similarly, the antenna 1610, the communication interface 1606, and/or the processing circuitry 1602 may be configured to perform any transmitting operations described herein as being performed by the network node. Any information, data and/or signals may be transmitted to a UE, another network node and/or any other network equipment.

The power source 1608 provides power to the various components of network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., an outlet connected to a power grid) via an input circuitry or interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 16 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

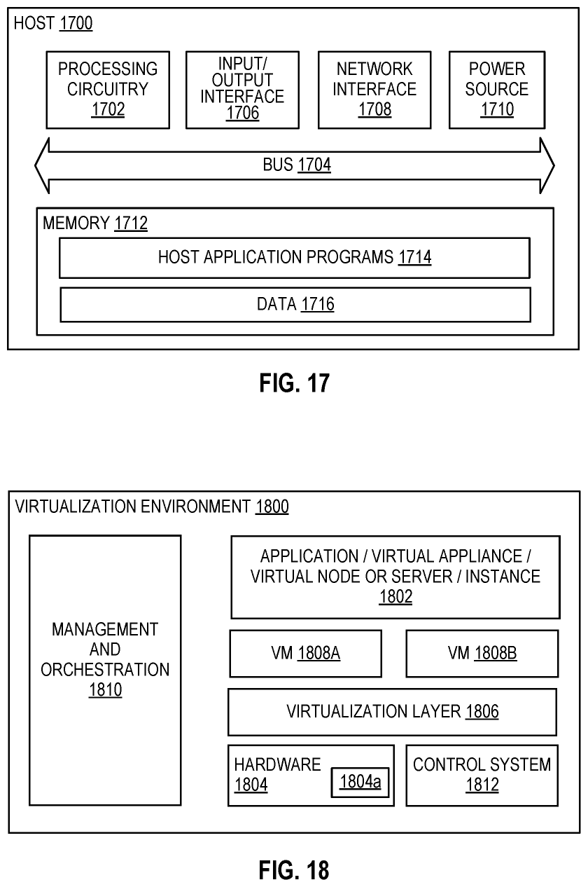

FIG. 17 is a block diagram of a host 1700, which may be an embodiment of the host 1416 of FIG. 14, in accordance with various aspects described herein. As used herein, the host 1700 may be or comprise various combinations hardware and/or software, including a standalone server, a blade server, a cloud-implemented server, a distributed server, a virtual machine, container, or processing resources in a server farm. The host 1700 may provide one or more services to one or more UEs.

The host 1700 includes processing circuitry 1702 that is operatively coupled via a bus 1704 to an input/output interface 1706, a network interface 1708, a power source 1710, and a memory 1712. Other components may be included in other embodiments. Features of these components may be substantially similar to those described with respect to the devices of previous figures, such as FIGS. 15 and 16, such that the descriptions thereof are generally applicable to the corresponding components of host 1700.

The memory 1712 may include one or more computer programs including one or more host application programs 1714 and data 1716, which may include user data, e.g., data generated by a UE for the host 1700 or data generated by the host 1700 for a UE. Embodiments of the host 1700 may utilize only a subset or all of the components shown. The host application programs 1714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1714 may also provide for user authentication and licensing checks and may periodically report health, routes, and content availability to a central node, such as a device in or on the edge of a core network. Accordingly, the host 1700 may select and/or indicate a different host for over-the-top services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in the virtualization environment 1800 to implement some of the features, functions, and/or benefits of some of the embodiments disclosed herein.

Hardware 1804 includes processing circuitry, memory that stores software and/or instructions (referred to collectively as computer program product 1804a) executable by hardware processing circuitry, and/or other hardware devices as described herein, such as a network interface, input/output interface, and so forth. Software may be executed by the processing circuitry to instantiate one or more virtualization layers 1806 (also referred to as hypervisors or virtual machine monitors (VMMs)), provide VMs 1808a and 1808b (one or more of which may be generally referred to as VMs 1808), and/or perform any of the functions, features and/or benefits described in relation with some embodiments described herein. The virtualization layer 1806 may present a virtual operating platform that appears like networking hardware to the VMs 1808.

The VMs 1808 comprise virtual processing, virtual memory, virtual networking or interface and virtual storage, and may be run by a corresponding virtualization layer 1806. Different embodiments of the instance of a virtual appliance 1802 may be implemented on one or more of VMs 1808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premises equipment.

In the context of NFV, a VM 1808 may be a software implementation of a physical machine that runs programs as if they were executing on a physical, non-virtualized machine. Each of the VMs 1808, and that part of hardware 1804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1808 on top of the hardware 1804 and corresponds to the application 1802.

Hardware 1804 may be implemented in a standalone network node with generic or specific components. Hardware 1804 may implement some functions via virtualization. Alternatively, hardware 1804 may be part of a larger cluster of hardware (e.g., such as in a data center or CPE) where many hardware nodes work together and are managed via management and orchestration 1810, which, among others, oversees lifecycle management of applications 1802. In some embodiments, hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1812 which may alternatively be used for communication between hardware nodes and radio units.

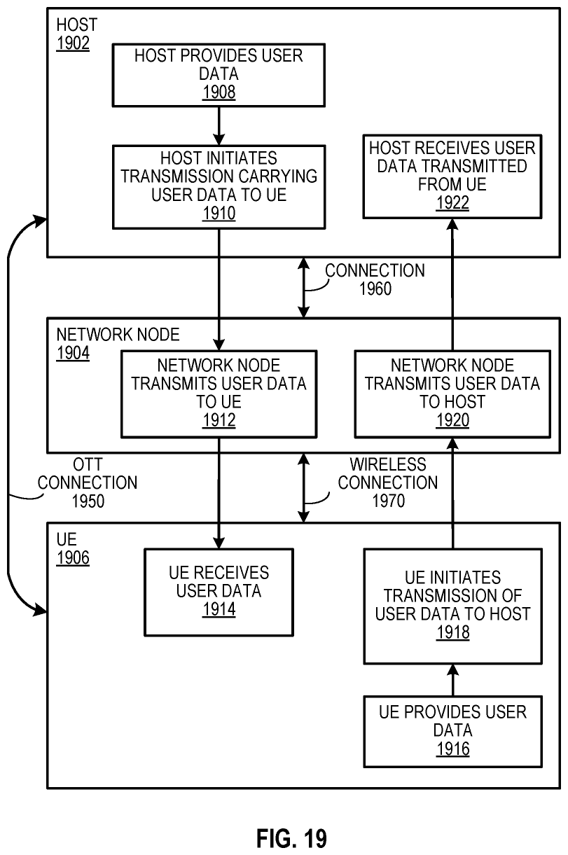

FIG. 19 shows a communication diagram of a host 1902 communicating via a network node 1904 with a UE 1906 over a partially wireless connection in accordance with some embodiments. Example implementations, in accordance with various embodiments, of the UE (such as a UE 1412a of FIG. 14 and/or UE 1500 of FIG. 15), network node (such as network node 1410a of FIG. 14 and/or network node 1600 of FIG. 16), and host (such as host 1416 of FIG. 14 and/or host 1700 of FIG. 17) discussed in the preceding paragraphs will now be described with reference to FIG. 19.

Like host 1700, embodiments of host 1902 include hardware, such as a communication interface, processing circuitry, and memory. The host 1902 also includes software, which is stored in or accessible by the host 1902 and executable by the processing circuitry. The software includes a host application that may be operable to provide a service to a remote user, such as the UE 1906 connecting via an over-the-top (OTT) connection 1950 extending between the UE 1906 and host 1902. In providing the service to the remote user, a host application may provide user data which is transmitted using the OTT connection 1950.

The network node 1904 includes hardware enabling it to communicate with the host 1902 and UE 1906. The connection 1960 may be direct or pass through a core network (like core network 1406 of FIG. 14) and/or one or more other intermediate networks, such as one or more public, private, or hosted networks. For example, an intermediate network may be a backbone network or the Internet.

The UE 1906 includes hardware and software, which is stored in or accessible by UE 1906 and executable by the UE's processing circuitry. The software includes a client application, such as a web browser or operator-specific “app” that may be operable to provide a service to a human or non-human user via UE 1906 with the support of the host 1902. In the host 1902, an executing host application may communicate with the executing client application via the OTT connection 1950 terminating at the UE 1906 and host 1902. In providing the service to the user, the UE's client application may receive request data from the host's host application and provide user data in response to the request data. The OTT connection 1950 may transfer both the request data and the user data. The UE's client application may interact with the user to generate the user data that it provides to the host application through the OTT connection 1950.

The OTT connection 1950 may extend via a connection 1960 between the host 1902 and the network node 1904 and via a wireless connection 1970 between the network node 1904 and the UE 1906 to provide the connection between the host 1902 and the UE 1906. The connection 1960 and wireless connection 1970, over which the OTT connection 1950 may be provided, have been drawn abstractly to illustrate the communication between the host 1902 and the UE 1906 via the network node 1904, without explicit reference to any intermediary devices and the precise routing of messages via these devices.

As an example of transmitting data via the OTT connection 1950, in step 1908, the host 1902 provides user data, which may be performed by executing a host application. In some embodiments, the user data is associated with a particular human user interacting with the UE 1906. In other embodiments, the user data is associated with a UE 1906 that shares data with the host 1902 without explicit human interaction. In step 1910, the host 1902 initiates a transmission carrying the user data towards the UE 1906. The host 1902 may initiate the transmission responsive to a request transmitted by the UE 1906. The request may be caused by human interaction with the UE 1906 or by operation of the client application executing on the UE 1906. The transmission may pass via the network node 1904, in accordance with the teachings of the embodiments described throughout this disclosure. Accordingly, in step 1912, the network node 1904 transmits to the UE 1906 the user data that was carried in the transmission that the host 1902 initiated, in accordance with the teachings of the embodiments described throughout this disclosure. In step 1914, the UE 1906 receives the user data carried in the transmission, which may be performed by a client application executed on the UE 1906 associated with the host application executed by the host 1902.

In some examples, the UE 1906 executes a client application which provides user data to the host 1902. The user data may be provided in reaction or response to the data received from the host 1902. Accordingly, in step 1916, the UE 1906 may provide user data, which may be performed by executing the client application. In providing the user data, the client application may further consider user input received from the user via an input/output interface of the UE 1906. Regardless of the specific manner in which the user data was provided, the UE 1906 initiates, in step 1918, transmission of the user data towards the host 1902 via the network node 1904. In step 1920, in accordance with the teachings of the embodiments described throughout this disclosure, the network node 1904 receives user data from the UE 1906 and initiates transmission of the received user data towards the host 1902. In step 1922, the host 1902 receives the user data carried in the transmission initiated by the UE 1906.

One or more of the various embodiments improve the performance of OTT services provided to the UE 1906 using the OTT connection 1950, in which the wireless connection 1970 forms the last segment. More precisely, embodiments described herein can facilitate improved management of UEs and network resources by providing a first network node with a richer insight into data traffic of UEs served by a second network node as well as predicted migration of such data traffic into the first network node's coverage area. For example, by using such information, the first network node can improve and/or optimize operations of its served cells, e.g., by interference management and MLB, thereby improving spectral efficiency and throughput in the served cells. As another example, the first network node can infer and/or predict a change in interference to UEs that are served by the first network node (e.g., near cell edge), and proactively configure communication with the affected UEs to be more robust against interference.

Embodiments also facilitate network nodes to improve configuration of, and/or resource allocation for, a UE so as to reduce UE energy consumption and/or improve QoS for applications and services run by the UE (e.g., via DRX and/or DTX cycles, carrier aggregation, multi-connectivity, RRC state settings, beam tracking, etc.). As an example, by combining information from multiple UEs, a network node can obtain a composite view of current data traffic and predicted future traffic in cells and/or beams, as well as for different applications and/or types of services. This information facilitates network node resource management, such as activating new cells or beam coverage areas, deactivating existing cells or beam coverage areas, configure UEs to improve spectral efficiency in a cell, etc.

These above-described improvements can increase the value of OTT services to end users and service providers through increased UE battery life as well as better reliability, less latency, and/or better QoS/quality of experience (QoE) for OTT services.

In an example scenario, factory status information may be collected and analyzed by the host 1902. As another example, the host 1902 may process audio and video data which may have been retrieved from a UE for use in creating maps. As another example, the host 1902 may collect and analyze real-time data to assist in controlling vehicle congestion (e.g., controlling traffic lights). As another example, the host 1902 may store surveillance video uploaded by a UE. As another example, the host 1902 may store or control access to media content such as video, audio, VR or AR which it can broadcast, multicast or unicast to UEs. As other examples, the host 1902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1950 between the host 1902 and UE 1906, in response to variations in the measurement results. The measurement procedure and/or the network functionality for reconfiguring the OTT connection may be implemented in software and hardware of the host 1902 and/or UE 1906. In some embodiments, sensors (not shown) may be deployed in or in association with other devices through which the OTT connection 1950 passes; the sensors may participate in the measurement procedure by supplying values of the monitored quantities exemplified above, or supplying values of other physical quantities from which software may compute or estimate the monitored quantities. The reconfiguring of the OTT connection 1950 may include message format, retransmission settings, preferred routing etc.; the reconfiguring need not directly alter the operation of the network node 1904. Such procedures and functionalities may be known and practiced in the art. In certain embodiments, measurements may involve proprietary UE signaling that facilitates measurements of throughput, propagation times, latency and the like, by the host 1902. The measurements may be implemented in that software causes messages to be transmitted, in particular empty or ‘dummy’ messages, using the OTT connection 1950 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Embodiments of the techniques and apparatus described herein also include, but are not limited to, the following enumerated examples:

A1. A method for a first network node of a wireless network, the method comprising:
receiving, from a second network node of the wireless network, a first message comprising traffic status information for the second network node; and
performing one or more of the following based on the traffic status information:
   predicting a change in load and/or interference in a coverage area of the first network node;
   adjusting configurations of one or more cells and/or one or more beams served by the first network node;
   mobility load balancing (MLB) with respect to one or more UEs served by the first network node; and
   configuring one or more UEs served by the first network node to use communication settings that are more robust to interference.

A2. The method of embodiment A1, wherein the traffic status information for the second network node includes the following:
measurements and/or predictions of traffic during one or more time intervals, associated with one or more of the following:
   respective UEs served by the second network node,
   an aggregated plurality of UEs served by the second network node, and
   one or more coverage area of the second network node;
indication of predicted traffic migration from the one or more coverage areas of the second network node to one or more coverage areas of the first network node.

A3. The method of embodiment A2, wherein the traffic status information for the second network node comprises respective subsets of traffic status information, the respective subsets relating to different ones of any of the following associated with the second network node: cell, beam coverage area, reference signal (RS) coverage area, network slice, tracking area, public land mobile network (PLMN), frequency range, transmission point, resource type.

A4. The method of any of embodiments A2-A3, wherein the traffic status information for the second network node also includes indications of one or more of the following:
validity, accuracy, reliability, stability, precision, and/or uncertainty of the measurements and/or predictions; the one or more time intervals; and
locations of one or more UEs for which traffic status information is reported.

A5. The method of any of embodiments A2-A4, wherein the measurements and/or predictions include any of the following traffic metrics: data volume, number of UEs, packet size, bit rate, packet delay, packet delay jitter, packet error rate, number of consecutive failed packets, inter-packet arrival time, service downtime, number of bursts in an application level message, application level message size, end-to-end latency.

A6. The method of embodiment A5, wherein each traffic metric comprising the measurements and/or predictions is reported as one of the following for each time interval:
one or more statistics including average, maximum, minimum, standard deviation, and variance; a total or aggregate amount; and
predicted change with respect to current traffic, a previous time interval, or a previously reported measurement or prediction.

A7. The method of any of embodiments A2-A6, wherein the indication of predicted traffic migration includes a plurality of traffic amounts, each traffic amount associated with a different combination of a coverage area of the second network node and a coverage areas of the first network node.

A8. The method of embodiment A1, wherein:
the first message is a handover request for a particular UE served by the second network node; and
the traffic status information includes one or more of the following:
   measurements of traffic for the particular UE during one or more previous time intervals, and
   predictions of traffic for the particular UE during one or more future time intervals.

A9. The method of any of embodiments A1-A7, further comprising:
transmitting, to the second network node, a second message including a request for the second network node to provide the traffic status information in accordance with one or more configuration parameters included in the second message; and
receiving one of the following from the second network node in response to the second message:
   a third message indicating that the second network node can provide some or all of the requested traffic status information and has initiated measurements and/or predictions in accordance with the configuration parameters; or
   a fourth message indicating that the second network node cannot provide the requested traffic status information and has not initiated measurements and/or predictions in accordance with the configuration parameters.

A10. The method of embodiment A9, wherein receiving the first message is conditioned upon receiving the third message.

A11. The method of any of embodiments A9-A10, wherein the one or more configuration parameters include indications of one or more of the following for which traffic status information is requested:
one or more network slices;
one or more service types;
one or more resource types;
one or more coverage areas of the second network node;
one or more coverage areas of the first network node;
one or more traffic metrics;
one or more time intervals; and
one or more thresholds for accuracy, precision, and/or uncertainty of the measurements and/or predictions.

A12. The method of any of embodiments A9-A11, wherein the one or more configuration parameters include indications of one or more of the following:
one or more reporting formats;
one or more triggering conditions for obtaining the requested traffic status information; and
one or more triggering conditions for reporting the requested traffic status information.

A13. The method of any of embodiments A1-A12, wherein:
the traffic status information includes a prediction of a change in traffic for one or more UEs in a coverage area of the second network node;
predicting a change in interference in the coverage area of the first network node is based on the prediction of a change in traffic; and
the one or more UEs configured to use more robust communication settings are in the coverage area for which the changed interference is predicted.

A14. The method of any of embodiments A1-A13, wherein adjusting configurations of one or more cells and/or one or more beams based on the traffic status information includes one or more of the following:
adjusting coverage and/or capacity of at least one of the cells;
adjusting one or more beam coverage areas within the one or more cells; and
assigning one or more UEs served by the first network node to respective network slices.

B1. A method for a second network node of a wireless network, the method comprising:
performing one or more of the following operations to determine traffic status information for the second network node:
   measuring and/or predicting traffic during one or more time intervals, associated with one or more of the following:
      respective UEs served by the second network node, and an aggregated plurality of UEs served by the second network node; and
   predicting traffic migration from one or more coverage areas of the second network node to one or more coverage areas of the first network node; and
sending, to a first network node of the wireless network, a first message comprising the determined traffic status information.

B2. The method of embodiment B1, wherein the traffic status information for the second network node comprises respective subsets of traffic status information, the respective subsets relating to different ones of any of the following associated with the second network node: cell, beam coverage area, reference signal (RS) coverage area, network slice, tracking area, public land mobile network (PLMN), frequency range, transmission point, resource type.

B3. The method of any of embodiments B1-B2, wherein the traffic status information for the second network node also includes indication of one or more of the following:
validity, accuracy, reliability, stability, precision, and/or uncertainty of the measurements and/or predictions; the one or more time intervals; and
locations of one or more UEs for which traffic status information is reported.

B4. The method of any of embodiments B1-B3, wherein the measurements and/or predictions include any of the following traffic metrics: data volume, number of UEs, packet size, bit rate, packet delay, packet delay jitter, packet error rate, number of consecutive failed packets, inter-packet arrival time, service downtime, number of bursts in an application level message, application level message size, end-to-end latency.

B5. The method of embodiment B4, wherein each traffic metric comprising the measurements and/or predictions is reported as one of the following for each time interval:
one or more statistics including average, maximum, minimum, standard deviation, and variance; a total or aggregate amount; and
predicted change with respect to current traffic, a previous time interval, or a previously reported measurement or prediction.

B6. The method of any of embodiments B1-B5, wherein the indication of predicted traffic migration includes a plurality of traffic amounts, each traffic amount associated with a different combination of a coverage area of the second network node and a coverage areas of the first network node.

B7. The method of embodiment B1, wherein:
the first message is a handover request for a particular UE served by the second network node; and
the traffic status information includes one or more of the following:
   measurements of traffic for the particular UE during one or more previous time intervals, and
   predictions of traffic for the particular UE during one or more future time intervals.

B8. The method of any of embodiments B1-B6, further comprising:
receiving, from the first network node, a second message including a request for the second network node to provide the traffic status information in accordance with one or more configuration parameters included in the second message; and
sending one of the following to the first network node in response to the second message:
   a third message indicating that the second network node can provide some or all of the requested traffic status information and has initiated measurements and/or predictions in accordance with the configuration parameters; or
   a fourth message indicating that the second network node cannot provide the requested traffic status information and has not initiated measurements and/or predictions in accordance with the configuration parameters.

B9. The method of embodiment B8, wherein receiving the first message is responsive to sending the third message.

B10. The method of any of embodiments B8-B9, wherein the one or more configuration parameters include indications of one or more of the following for which traffic status information is requested:
one or more network slices;
one or more service types;
one or more resource types;
one or more coverage areas of the second network node;
one or more coverage areas of the first network node;
one or more traffic metrics;
one or more time intervals; and
one or more thresholds for accuracy, precision, and/or uncertainty of the measurements and/or predictions.

B11. The method of any of embodiments B8-B10, wherein the one or more configuration parameters include indications of one or more of the following:
one or more reporting formats;
one or more triggering conditions for obtaining the requested traffic status information; and
one or more triggering conditions for reporting the requested traffic status information.

B12. The method of any of embodiments B1-B11, wherein:
the method further comprises receiving, from a plurality of UEs served by second network node, measurements and/or predictions of one or more of the following traffic metrics: data volume, packet size, bit rate, packet delay, packet delay jitter, packet error rate, number of consecutive failed packets, inter-packet arrival time, service downtime; and
measuring and/or predicting the traffic for the second network node during the one or more time intervals is based on the measurements and/or predictions received from the plurality of UEs.

B13. The method of any of embodiments B1-B12, wherein predicting traffic migration from one or more coverage areas of the second network node to one or more coverage areas of the first network node comprises determining that one or more UEs served by the second network node are expected to perform mobility operations toward the first network node during a subsequent time interval, based on one or more of the following:
UE position, orientation, and/or speed information determined by the second network node;
UE position, orientation, and/or speed information reported by the respective UEs;
serving cell and/or neighbor cell measurements reported by the respective UEs;
indication of predicted traffic migration from one or more coverage areas of a third network node to one or more coverage areas of the second network node; and
historical UE mobility patterns in the coverage areas in which the one or more UEs are located.

B14. The method of any of embodiments B1-B13, further comprising receiving, from a third network node of the wireless network, a further first message comprising traffic status information for the third network node, wherein the traffic status information for the second network is determined based on traffic status information for the third network node.

C1. A first network node configured to operate in a wireless network, the first network node comprising:
communication interface circuitry configured to communicate with user equipment (UEs) and with a second network node in the wireless network; and
processing circuitry operatively coupled to the communication interface circuitry, whereby the processing circuitry and the communication interface circuitry are configured to perform operations corresponding to any of the methods of embodiments A1-A14.

C2. A first network node configured to operate in a wireless network, the first network node being further configured to perform operations corresponding to any of the methods of embodiments A1-A14.

C3. A non-transitory, computer-readable medium storing computer-executable instructions that, when executed by processing circuitry of a first network node configured to operate in a wireless network, configure the first network node to perform operations corresponding to any of the methods of embodiments A1-A14.

C4. A computer program product comprising computer-executable instructions that, when executed by processing circuitry of a first network node configured to operate in a wireless network, configure the first network node to perform operations corresponding to any of the methods of embodiments A1-A14.

D1. A second network node configured to operate in a wireless network, the second network node comprising:
communication interface circuitry configured to communicate with user equipment (UEs) and with a first network node in the wireless network; and
processing circuitry operatively coupled to the communication interface circuitry, whereby the processing circuitry and the communication interface circuitry are configured to perform operations corresponding to any of the methods of embodiments B1-B13.

D2. A second network node configured to operate in a wireless network, the second network node being further configured to perform operations corresponding to any of the methods of embodiments B1-B13.

D3. A non-transitory, computer-readable medium storing computer-executable instructions that, when executed by processing circuitry of a second network node configured to operate in a wireless network, configure the second network node to perform operations corresponding to any of the methods of embodiments B1-B13.

D4. A computer program product comprising computer-executable instructions that, when executed by processing circuitry of a second network node configured to operate in a wireless network, configure the second network node to perform operations corresponding to any of the methods of embodiments B1-B13.

E1. A method for a network node of a wireless network, the method comprising:
transmitting respective first messages to one or more user equipment (UEs), each first message configuring and/or requesting a UE to provide traffic state information;
receiving, from the one or more UEs, respective second messages comprising respective traffic state reports; and
performing one or more of the following based on the received second messages:
   based on the traffic state report received from a particular UE, configuring the particular UE with one or more of the following: assigned resources, settings related to energy consumption, and a mobility operation; and
   based on an aggregation of the received traffic state reports, adjusting configurations of one or more cells and/or one or more beams served by the network node.

E2. The method of embodiment E1, wherein each first message includes identifiers of one or more of the following associated with the requested traffic state information:
one or more network slices for which measurements and/or predictions are requested from the receiving UE;
one or more service types for which measurements and/or predictions are requested from the receiving UE;
one or more applications for which measurements and/or predictions are requested from the receiving UE;
one or more types of traffic measurements and/or predictions requested for each identified application, service type, or network slice;
one or more traffic pattern types for which the identified traffic measurements and/or predictions are requested; and
one or more environmental conditions associated with the identified traffic measurements and/or predictions.

E3. The method of embodiment E2, wherein each first message also includes indications of one or more of the following:
one or more accuracies, each accuracy associated with a different portion of the requested traffic measurements and/or predictions;
quality of service (QoS) information associated with traffic on which the requested traffic measurements and/or predictions should be performed;
one or more reporting formats for the requested traffic measurements and/or predictions;
one or more triggering conditions for performing the requested traffic measurements and/predictions; and
one or more triggering conditions for reporting the requested traffic measurements and/predictions.

E4. The method of embodiment E3, wherein the requested reporting formats include any of the following: absolute value, scaled absolute value, relative to a reference value, count, index to a table of values.

E5. The method of any of embodiments E2-E4, wherein the identified traffic pattern types include any of the following: periodic, deterministic periodic, non-deterministic periodic, aperiodic, deterministic aperiodic, non-deterministic periodic, constant, regular, uplink, downlink, bidirectional.

E6. The method of any of embodiments E2-E5, wherein the identified environmental conditions include any of the following: one or more serving cells, one or more beams, one or more positioning reference signals, a geographic location, a UE speed, a UE orientation, a time, a time period.

E7. The method of any of embodiments E2-E6, wherein the identified types of traffic measurements and/or predictions include any of the following:
average, maximum, minimum, standard deviation, and/or variance of one or more traffic metrics during one or more time intervals;
total or aggregate of one or more traffic metrics during one or more time intervals;
predicted change of one or more traffic metrics with respect to current traffic, a previous time interval, or a previously reported traffic measurement or prediction; and
quantitative or qualitative.

E8. The method of embodiment E7, wherein the one or more traffic metrics include any of the following: service rate, throughput, packet size, bit rate, data volume, packet delay, packet delay jitter, packet error rate, number of consecutive failed packets, inter-packet arrival time, next packet arrival time, service downtime.

E9. The method of any of embodiments E1-E8, wherein each traffic state report includes:
measurements and/or predictions of traffic state information by a particular UE in accordance with the first message sent to the particular UE; and
identifiers of one or more of the following associated with the measurements and/or predictions: one or more service types; one or more applications; one or more traffic pattern types; one or more accuracies; one or more quality of service (QoS) information; one or more prediction algorithms.

E10. The method of any of embodiments E1-E9, wherein configuring a particular UE based on the traffic state report received from the particular UE comprises one or more of the following:
selectively configuring the particular UE to operate in a non-connected state based on a predicted arrival time of a next packet; and
selectively performing beam tracking for the particular UE based on a predicted arrival time of a next packet.

E11. The method of any of embodiments E1-E10, wherein adjusting configurations of one or more cells and/or one or more beams based on an aggregation of the received traffic state reports comprises one or more of the following:
adjusting coverage and/or capacity of at least one of the cells;
adjusting one or more beam coverage areas within the one or more cells;
assigning the UEs to respective network slices;
adjusting mobility settings with respect to one or more neighbor cells served by another network node; and
providing aggregated QoS information to a core network.

E12. The method of any of embodiments E1-E11, further comprising receiving, from the one or more UEs, respective indications of UE capabilities for traffic status reporting, wherein the respective first messages are based on the respective UE capabilities.

F1. A method for a user equipment (UE) operating in a wireless network, the method comprising: receiving, from a network node, a first message configuring and/or requesting the UE to provide traffic state information;
performing measurements and/or predictions to determine UE traffic state information in accordance with the first message; and
sending, to the network node in accordance with the first message, a second message comprising a traffic state report that includes the determined UE traffic state information.

F2. The method of embodiment F1, wherein the first message includes identifiers of one or more of the following associated with the requested traffic state information:
one or more network slices for which measurements and/or predictions are requested from the UE;
one or more service types for which measurements and/or predictions are requested from the UE;
one or more applications for which measurements and/or predictions are requested from the UE;
one or more types of traffic measurements and/or predictions requested for each identified application, service type, or network slice;
one or more traffic pattern types for which the identified traffic measurements and/or predictions are requested; and
one or more environmental conditions associated with the identified traffic measurements and/or predictions.

F3. The method of embodiment F2, wherein each first message also includes indications of one or more of the following:
one or more accuracies, each accuracy associated with a different portion of the requested traffic measurements and/or predictions;
quality of service (QoS) information associated with traffic on which the requested traffic measurements and/or predictions should be performed;
one or more reporting formats for the requested traffic measurements and/or predictions;
one or more triggering conditions for performing the requested traffic measurements and/predictions; and
one or more triggering conditions for reporting the requested traffic measurements and/predictions.

F4. The method of embodiment F3, wherein the requested reporting formats include any of the following: absolute value, scaled absolute value, relative to a reference value, count, index to a table of values.

F5. The method of any of embodiments F2-F4, wherein the identified traffic pattern types include any of the following: periodic, deterministic periodic, non-deterministic periodic, aperiodic, deterministic aperiodic, non-deterministic periodic, constant, regular, uplink, downlink, bidirectional.

F6. The method of any of embodiments F2-F5, wherein the identified environmental conditions include any of the following: one or more serving cells, one or more beams, one or more positioning reference signals, a geographic location, a UE speed, a UE orientation, a time, a time period.

F7. The method of any of embodiments F2-F6, wherein the identified types of traffic measurements and/or predictions include any of the following:
average, maximum, minimum, standard deviation, and/or variance of one or more traffic metrics during one or more time intervals;
total or aggregate of one or more traffic metrics during one or more time intervals;
predicted change of one or more traffic metrics with respect to current traffic, a previous time interval, or a previously reported traffic measurement or prediction; and
quantitative or qualitative.

F8. The method of embodiment F7, wherein one or more traffic metrics include any of the following: service rate, throughput, packet size, bit rate, data volume, packet delay, packet delay jitter, packet error rate, number of consecutive failed packets, inter-packet arrival time, next packet arrival time, service downtime.

F9. The method of any of embodiments F1-F8, wherein the traffic state report also includes identifiers of one or more of the following associated with the measurements and/or predictions: one or more service types; one or more applications; one or more traffic pattern types; one or more accuracies; one or more quality of service (QoS) information; one or more prediction algorithms.

F10. The method of any of embodiments F1-F9, further comprising, in response to sending the traffic state report, receiving and applying a configuration, from the network node, of one or more of the following: assigned resources, settings related to energy consumption, and a mobility operation.

F11. The method of embodiment F10, wherein:
the traffic state report includes a predicted arrival time of a next packet; and
applying a configuration of settings related to energy consumption comprises operating in a non-connected state until proximately before the predicted arrival time of the next packet.

F12. The method of any of embodiments F1-F11, further comprising sending, to the network node, an indication of UE capabilities for traffic status reporting, wherein the first message is based on the indicated UE capabilities.

F13. The method of any of embodiments F1-F12, wherein:
the first message is received and the second message is sent by an access layer of the UE;
the first message includes a configuration for measurements and/or prediction of data traffic associated with a first application hosted by the UE;
performing measurements and/or predictions to determine UE traffic state information comprises: sending the configuration from the access layer to an application layer of the UE;
   performing, by the application layer according to the configuration, the measurements and/or predictions on data traffic associated with the first application; and
   sending the measurements and/or predictions from the application layer to the access layer.

G1. A network node configured to operate in a wireless network, the network node comprising:
communication interface circuitry configured to communicate with user equipment (UEs); and
processing circuitry operatively coupled to the communication interface circuitry, whereby the processing circuitry and the communication interface circuitry are configured to perform operations corresponding to any of the methods of embodiments E1-E12.

G2. A network node configured to operate in a wireless network, the network node being further configured to perform operations corresponding to any of the methods of embodiments E1-E12.

G3. A non-transitory, computer-readable medium storing computer-executable instructions that, when executed by processing circuitry of a network node configured to operate in a wireless network, configure the network node to perform operations corresponding to any of the methods of embodiments E1-E12.

G4. A computer program product comprising computer-executable instructions that, when executed by processing circuitry of a network node configured to operate in a wireless network, configure the network node to perform operations corresponding to any of the methods of embodiments E1-E12.

H1. A user equipment (UE) configured to operate in a wireless network, the UE comprising:
communication interface circuitry configured to communicate with a network node in the wireless network; and
processing circuitry operatively coupled to the communication interface circuitry, whereby the processing circuitry and the communication interface circuitry are configured to perform operations corresponding to any of the methods of embodiments F1-F13.

H2. A user equipment (UE) configured to operate in a wireless network, the UE being further configured to perform operations corresponding to any of the methods of embodiments F1-F13.

H3. A non-transitory, computer-readable medium storing computer-executable instructions that, when executed by processing circuitry of a user equipment (UE) configured to operate in a wireless network, configure the UE to perform operations corresponding to any of the methods of embodiments F1-F13.

H4. A computer program product comprising computer-executable instructions that, when executed by processing circuitry of a user equipment (UE) configured to operate in a wireless network, configure the UE to perform operations corresponding to any of the methods of embodiments F1-F13.

1.-39. (canceled)

40. A method for a first network node of a wireless network, the method comprising:
receiving, from a second network node of the wireless network, a first message comprising traffic status information for the second network node; and
performing one or more of the following operations based on the traffic status information:
predicting a change in load and/or interference in a coverage area of the first network node;
adjusting configurations of one or more cells and/or one or more beams served by the first network node;
requesting the second network node to adjust configurations of one or more cells and/or one or more beams served by the second network node;
mobility load balancing (MLB) with respect to one or more user equipment (UEs) served by the first network node; and
configuring one or more UEs served by the first network node to use communication settings that are more robust to interference.

41. The method of claim 40, wherein the traffic status information for the second network node includes the following:
measurements and/or predictions of traffic during one or more time intervals, associated with one or more of the following:
respective UEs served by the second network node,
an aggregated plurality of UEs served by the second network node, and
one or more coverage areas of the second network node; and
indication of predicted traffic migration from the one or more coverage areas of the second network node to one or more coverage areas of the first network node.

42. The method of claim 41, wherein:
the traffic status information for the second network node comprises respective subsets of traffic status information; and
the respective subsets are related to different ones of any of the following associated with the second network node: cell, beam coverage area, reference signal coverage area, network slice, tracking area, public land mobile network, frequency range, transmission point, and resource type.

43. The method of claim 41, wherein:
the traffic status information for the second network node also includes indications of one or more of the following:
accuracy, precision, stability, validity, reliability, precision, and/or uncertainty of the measurements and/or predictions,
the one or more time intervals, and
locations of one or more UEs for which traffic status information is reported; and
the traffic status information for the second network node includes one or more of the following traffic metrics: data volume, number of UEs, packet size, bit rate, packet delay, packet delay jitter, packet error rate, number of consecutive failed packets, inter-packet arrival time, service downtime, number of bursts in an application-level message, application-level message size, and end-to-end latency.

44. The method of claim 43, wherein each traffic metric is represented as one of the following, for each time interval:
one or more statistics including average, maximum, minimum, standard deviation, and variance;
a total or aggregate amount; and
predicted change with respect to current traffic, a previous time interval, or a previously reported measurement or prediction.

45. The method of claim 40, wherein:
the first message is a handover request for a particular UE served by the second network node; and
the traffic status information includes one or more of the following:
measurements of traffic for the particular UE during one or more previous time intervals, and
predictions of traffic for the particular UE during one or more future time intervals.

46. The method of claim 40, further comprising:
transmitting, to the second network node, a second message including a request for the second network node to provide the traffic status information in accordance with one or more configuration parameters included in the second message; and
receiving one of the following from the second network node in response to the second message:
a third message indicating that the second network node can provide some or all of the requested traffic status information and has initiated measurements and/or predictions in accordance with the configuration parameters; or
a fourth message indicating that the second network node cannot provide the requested traffic status information and has not initiated measurements and/or predictions in accordance with the configuration parameters.

47. The method of claim 46, wherein:
the one or more configuration parameters include indications of one or more of the following for which traffic status information is requested:
one or more network slices,
one or more service types,
one or more resource types,
one or more coverage areas of the second network node,
one or more coverage areas of the first network node,
one or more traffic metrics,
one or more time intervals, and
one or more thresholds for accuracy, precision, stability, validity, reliability, precision, and/or uncertainty of the measurements and/or predictions; and
the one or more configuration parameters include indications of one or more of the following:
one or more reporting formats,
one or more triggering conditions for obtaining the requested traffic status information, and
one or more triggering conditions for reporting the requested traffic status information.

48. The method of claim 40, wherein:
the traffic status information for the second network node includes a prediction of a change in traffic for one or more UEs in a coverage area of the second network node;
predicting a change in interference in the coverage area of the first network node comprises:
determining that the one or more UEs served by the first network node are proximate to the coverage area of the second network node; and
predicting a change in interference to the one or more UEs served by the first network node based on the predicted change in traffic for the one or more UEs in the coverage area of the second network node; and
the one or more UEs served by the first network node are configured to use more robust communication settings based on the predicted change in interference.

49. The method of claim 40, wherein adjusting configurations of one or more cells and/or one or more beams based on the traffic status information includes one or more of the following:
adjusting coverage and/or capacity of at least one of the cells;
adjusting one or more beam coverage areas within the one or more cells;
activating one or more additional cells and/or one or more additional frequency resources in one or more currently activated cells; and
assigning one or more UEs served by the first network node to respective network slices.

50. The method of claim 49, wherein:
predicting a change in load in a coverage area of the first network node comprises predicting that one or more UEs served by the second network node are moving to the coverage area of the first network node; and
activating the one or more additional cells and/or the one or more additional frequency resources is responsive to predicting that the one or more UEs served by the second network node are moving to the coverage area of the first network node.

51. A method for a second network node of a wireless network, the method comprising:
performing one or more of the following to determine traffic status information for the second network node:
measuring and/or predicting traffic, during one or more time intervals, that is associated with one or more of the following:
respective user equipment (UEs) served by the second network node,
an aggregated plurality of UEs served by the second network node, and
one or more coverage areas of the second network node; and
predicting traffic migration from one or more coverage areas of the second network node to one or more coverage areas of a first network node of the wireless network; and
sending, to the first network node, a first message comprising the determined traffic status information.

52. The method of claim 51, wherein
the traffic status information for the second network node comprises respective subsets of traffic status information; and
the respective subsets are related to different ones of any of the following associated with the second network node: cell, beam coverage area, reference signal coverage area, network slice, tracking area, public land mobile network, frequency range, transmission point, and resource type.

53. The method of claim 51, wherein:
the traffic status information for the second network node also includes indications of one or more of the following:
accuracy, precision, stability, validity, reliability, precision, and/or uncertainty of the measurements and/or predictions,
the one or more time intervals, and
locations of one or more UEs for which traffic status information is reported; and
the traffic status information for the second network node includes one or more of the following traffic metrics: data volume, number of UEs, packet size, bit rate, packet delay, packet delay jitter, packet error rate, number of consecutive failed packets, inter-packet arrival time, service downtime, number of bursts in an application-level message, application-level message size, and end-to-end latency.

54. The method of claim 53, wherein each traffic metric is represented as one of the following, for each time interval:
one or more statistics including average, maximum, minimum, standard deviation, and variance;
a total or aggregate amount; and
predicted change with respect to current traffic, a previous time interval, or a previously reported measurement or prediction.

55. The method of claim 51, wherein:
the first message is a handover request for a particular UE served by the second network node; and
the traffic status information includes one or more of the following:
measurements of traffic for the particular UE during one or more previous time intervals, and
predictions of traffic for the particular UE during one or more future time intervals.

56. The method of claim 51, further comprising:
receiving, from the first network node, a second message including a request for the second network node to provide the traffic status information in accordance with one or more configuration parameters included in the second message; and
sending one of the following to the first network node in response to the second message:
a third message indicating that the second network node can provide some or all of the requested traffic status information and has initiated measurements and/or predictions in accordance with the configuration parameters; or
a fourth message indicating that the second network node cannot provide the requested traffic status information and has not initiated measurements and/or predictions in accordance with the configuration parameters.

57. The method of claim 56, wherein:
the one or more configuration parameters include indications of one or more of the following for which traffic status information is requested:
one or more network slices,
one or more service types,
one or more resource types,
one or more coverage areas of the second network node,
one or more coverage areas of the first network node,
one or more traffic metrics,
one or more time intervals, and
one or more thresholds for accuracy, precision, stability, validity, reliability, precision, and/or uncertainty of the measurements and/or predictions; and
the one or more configuration parameters include indications of one or more of the following:
one or more reporting formats,
one or more triggering conditions for obtaining the requested traffic status information, and
one or more triggering conditions for reporting the requested traffic status information.

58. The method of claim 51, wherein predicting traffic migration from one or more coverage areas of the second network node to one or more coverage areas of the first network node comprises determining that one or more UEs served by the second network node are expected to perform mobility operations toward the first network node during a subsequent time interval, based on one or more of the following:
UE position, orientation, and/or speed information determined by the second network node;
UE position, orientation, and/or speed information reported by the respective UEs;
serving cell and/or neighbor cell measurements reported by the respective UEs;
indication of predicted traffic migration from one or more coverage areas of a third network node to one or more coverage areas of the second network node; and
historical UE mobility patterns in the coverage areas in which the one or more UEs are located.

59. The method of claim 51, further comprising, in response to sending the first message comprising the determined traffic status information, receiving from the first network node a request to adjust configurations of one or more cells and/or one or more beams served by the second network node.

60. A first network node configured to operate in a wireless network, the first network node comprising:
communication interface circuitry configured to communicate with a second network node in the wireless network and with one or more user equipment, UEs served by the first network node; and
processing circuitry operatively coupled to the communication interface circuitry, whereby the processing circuitry and the communication interface circuitry are configured to:
receive, from the second network node, a first message comprising traffic status information for the second network node; and
perform one or more of the following operations based on the traffic status information:
predicting a change in load and/or interference in a coverage area of the first network node;
adjusting configurations of one or more cells and/or one or more beams served by the first network node;
requesting the second network node to adjust configurations of one or more cells and/or one or more beams served by the second network node;
mobility load balancing (MLB) with respect to the one or more UEs; and
configuring the one or more UEs to use communication settings that are more robust to interference.

61. A second network node configured to operate in a wireless network, the second network node comprising:
communication interface circuitry configured to communicate with a first network node in the wireless network and with one or more user equipment, UEs served by the second network node; and
processing circuitry operatively coupled to the communication interface circuitry, whereby the processing circuitry and the communication interface circuitry are configured to perform the method of claim 51.
